(19) United States
(12) Patent Application Publication
(10) Pub. No.: US 2026/0274125 A1
(43) Pub. Date: Sep. 17, 2026

(54) ROTATABLE CHILD SEAT WITH REMOVABLE BOOSTER

(71) Applicant: WONDERLAND SWITZERLAND AG, Steinhausen (CH)

(72) Inventors: ANDREW J. TAYLOR, Morgantown, PA (US); ANDREW J. HORST, Morgantown, PA (US); CURTIS M. HARTENSTINE, Morgantown, PA (US); NATHANIEL W. KEEBLER, Morgantown, PA (US); PATRICK J.G. BOWERS, Morgantown, PA (US); ZACHARY C. HARTENSTINE, Morgantown, PA (US)

(21) Appl. No.: 19/469,452

(22) PCT Filed: Mar. 29, 2024
(86) PCT No.: PCT/US2024/022206

§ 371 Date: Sep. 26, 2025

Related U.S. Application Data
(60) Provisional application No. 63/493,209, filed on Mar. 30, 2023.
(60) Provisional application No. 63/504,057, filed on May 24, 2023.
(60) Provisional application No. 63/509,465, filed on Jun. 21, 2023.
(60) Provisional application No. 63/520,247, filed on Aug. 17, 2023.
(60) Provisional application No. 63/582,425, filed on Sep. 13, 2023.
(60) Provisional application No. 63/590,589, filed on Oct. 16, 2023.
(60) Provisional application No. 63/607,890, filed on Dec. 8, 2023.
(60) Provisional application No. 63/613,033, filed on Dec. 20, 2023.
(60) Provisional application No. 63/621,729, filed on Jan. 17, 2024.

(51) Int. Cl. B60N 2/28; B60N 2/90

(52) U.S. Cl. CPC B60N 2/2869; B60N 2/2821; B60N 2/286; B60N 2/2866; B60N 2/2875; B60N 2/929

(57) ABSTRACT

A child safety seat system positionable on a vehicle seat includes a support base and a child safety seat rotatably positionable on the support base. The child safety seat includes a first booster portion and a second booster portion. The first booster portion is separable from the second booster portion.

### CROSS REFERENCE TO RELATED APPLICATIONS

This application claims the benefit of U.S. Application No. 63/493,209, filed on Mar. 30, 2023; U.S. Application No. 63/504,057, filed on May 24, 2023; U.S. Application No. 63/509,465, filed on Jun. 21, 2023; U.S. Application No. 63/520,247, filed on Aug. 17, 2023; U.S. Application No. 63/582,425, filed on Sep. 13, 2023; U.S. Application No. 63/590,589, filed on Oct. 16, 2023; U.S. Application No. 63/607,890, filed on Dec. 8, 2023; U.S. Application No. 63/613,033, filed on Dec. 20, 2023; and U.S. Application No. 63/621,729, filed on Jan. 17, 2024, which is incorporated herein by reference in its entirety.

### FIELD

Embodiments of the present disclosure relate to the art of child restraint systems for use in a vehicle, and more particularly to child car seats having multiple use configurations.

### BACKGROUND

Some child car seats currently available on the market have multiple use configurations that allow for the seats to continue to be used as a child grows. For example, some child car seats can be selectively used in any one or more of: (1) a rear facing, reclined configuration for infants, (2) a forward facing, reclined configuration for toddlers, (3) a forward facing, high-back booster configuration for children weighing between, e.g., 40 pounds and 100 pounds, and (4) a forward facing, backless booster configuration for children weighing between, e.g., 40 pounds and 120 pounds.

### BRIEF DESCRIPTION

According to an embodiment, a child safety seat system positionable on a vehicle seat includes a support base and a child safety seat rotatably positionable on the support base. The child safety seat includes a first booster portion and a second booster portion. The first booster portion is separable from the second booster portion.

In addition to one or more of the features described above, or as an alternative, in further embodiments at least one of the first booster portion and the second booster portion is removably couplable to the support base.

In addition to one or more of the features described above, or as an alternative, in further embodiments at least one of the first booster portion and the second booster portion is loosely positionable about the support base.

In addition to one or more of the features described above, or as an alternative, in further embodiments least one of the first booster portion and the second booster portion is couplable to the support base via a booster locking mechanism.

In addition to one or more of the features described above, or as an alternative, in further embodiments the booster locking mechanism includes at least one locking member movably mounted to the at least one of the first booster portion and the second booster portion and an actuator operably coupled to the at least one locking member. The actuator is operable to transform the at least one locking member from a locked position to an unlocked position.

In addition to one or more of the features described above, or as an alternative, in further embodiments both the first booster portion and the second booster portion are removably couplable from the support base. The first booster portion is separable from the support base independently from the second booster portion.

In addition to one or more of the features described above, or as an alternative, in further embodiments the first booster portion is a seat back portion of the child safety seat and the second booster portion is a seat pan portion of the child safety seat.

In addition to one or more of the features described above, or as an alternative, in further embodiments the support base includes a first base member, a second base member movably mounted to the first base member, and a third base member movably mounted to the second base member.

In addition to one or more of the features described above, or as an alternative, in further embodiments the child safety seat is connectable directly to the third base member.

In addition to one or more of the features described above, or as an alternative, in further embodiments the third base member includes at least one attachment member and the second booster portion includes at least one positioning feature. The at least one attachment member is engageable with the at least one positioning feature to position the second booster portion about the support base.

In addition to one or more of the features described above, or as an alternative, in further embodiments the third base member includes at least one base interlock feature and the first booster portion includes at least one seat interlock feature. The at least one base interlock feature is engageable with the at least one seat interlock feature to couple the second booster portion to the support base.

In addition to one or more of the features described above, or as an alternative, in further embodiments the second booster portion includes an engagement feature movable relative to the second booster portion to selectively engage the at least one base interlock feature.

In addition to one or more of the features described above, or as an alternative, in further embodiments the engagement feature is a pin lock, the pin lock being translatable into an opening formed in the at least one base interlock feature.

In addition to one or more of the features described above, or as an alternative, in further embodiments the child safety seat includes at least one seat interlock feature and the third base member includes at least one base interlock feature, the at least one base interlock feature being engageable with the at least one seat interlock feature to couple the third base member to the child safety seat.

In addition to one or more of the features described above, or as an alternative, in further embodiments the third base member is rotatable with the child safety seat relative to the second base member.

In addition to one or more of the features described above, or as an alternative, in further embodiments the second base member includes a hook and the third base member includes a lip, the hook being engaged with the lip to define a path of rotation of the child safety seat.

In addition to one or more of the features described above, or as an alternative, in further embodiments the child safety seat is rotatable relative to the support base between a rearward-facing configuration and a forward-facing configuration. The second base member includes a base anchor member and the third base member includes a seat anchor member. The base anchor member is connectable to the seat anchor member when the child safety seat is in the forward-facing configuration.

In addition to one or more of the features described above, or as an alternative, in further embodiments the child safety seat is movable along an incline path relative to the support base.

In addition to one or more of the features described above, or as an alternative, in further embodiments the child safety seat is movable with the second base member and the third base member relative to the first base member along the incline path to adjust an incline of the child safety seat.

In addition to one or more of the features described above, or as an alternative, in further embodiments including a spin lock for selectively locking rotation of the child safety seat relative to the support base and at least one actuator operably coupled to the spin lock. The at least one actuator is operable to transform the spin lock between a locked position and an unlocked position.

In addition to one or more of the features described above, or as an alternative, in further embodiments the spin lock includes a plurality of lock pins and the support base includes a plurality of lock sections. The plurality of lock pins are engaged with the plurality of lock sections when the spin lock is in the locked position and the plurality of lock pins are disengaged from the plurality of lock sections when the spin lock is in the unlocked position.

In addition to one or more of the features described above, or as an alternative, in further embodiments the plurality of lock pins are operably coupled to one another by a connecting link.

In addition to one or more of the features described above, or as an alternative, in further embodiments the at least one actuator includes a handle and a tension member operably coupling the handle to one of the plurality of lock pins.

In addition to one or more of the features described above, or as an alternative, in further embodiments the support base includes a harness. The harness is receivable within at least one opening formed in the child safety seat when the child safety seat is connected to the support base.

In addition to one or more of the features described above, or as an alternative, in further embodiments the first booster portion includes at least one impact pod.

In addition to one or more of the features described above, or as an alternative, in further embodiments the first booster portion is a seat back portion and the at least one impact pod being arranged at a rear of the seat back portion.

In addition to one or more of the features described above, or as an alternative, in further embodiments the at least one impact pod substantially encircles the rear of the seat back portion.

In addition to one or more of the features described above, or as an alternative, in further embodiments when the child safety seat is in a forward-facing configuration, the at least one impact pod is vertically offset from the support base.

In addition to one or more of the features described above, or as an alternative, in further embodiments the second booster portion includes a stability foot movable between a retracted position and an extended position.

In addition to one or more of the features described above, or as an alternative, in further embodiments a bottom of the stability foot is positionable in contact with the vehicle seat in the extended position.

In addition to one or more of the features described above, or as an alternative, in further embodiments a recline lock mechanism is operable to selectively lock the child safety seat at a one of a plurality of positions along the incline path. An actuator is operably coupled to the recline lock mechanism. The actuator is operable to transform the recline lock mechanism between a locked position and an unlocked position.

In addition to one or more of the features described above, or as an alternative, in further embodiments a belt tensioner is mounted to the support base. The belt tensioner is movable between an open position and a closed position to apply a tension to a vehicle belt associated with the vehicle seat.

In addition to one or more of the features described above, or as an alternative, in further embodiments the first booster portion includes a cup holder. The cup holder is separable from the first booster portion.

In addition to one or more of the features described above, or as an alternative, in further embodiments the cup holder includes a flexible snap finger engageable with a protrusion extending from the first booster portion.

According to an embodiment, a child safety seat system positionable on a vehicle seat includes a support base and a child safety seat rotatably positionable on the support base. The child safety seat includes a seat pan portion and a seat back portion. The seat pan portion is removably couplable from the support base.

In addition to one or more of the features described above, or as an alternative, in further embodiments the seat back portion is removably couplable from the support base.

In addition to one or more of the features described above, or as an alternative, in further embodiments the seat pan portion is removably couplable from the seat back portion.

In addition to one or more of the features described above, or as an alternative, in further embodiments the support base includes a harness. The harness is receivable within at least one opening formed in the child safety seat when the child safety seat is connected to the support base.

In addition to one or more of the features described above, or as an alternative, in further embodiments the seat pan portion is loosely positionable about the support base.

In addition to one or more of the features described above, or as an alternative, in further embodiments the seat pan portion is couplable to the support base via a booster locking mechanism.

In addition to one or more of the features described above, or as an alternative, in further embodiments the booster locking mechanism includes at least one locking member movably mounted to the seat pan portion and an actuator operably coupled to the at least one locking member. The actuator is operable to transform the at least one locking member from a locked position to an unlocked position.

In addition to one or more of the features described above, or as an alternative, in further embodiments the actuator is located at the seat pan portion.

In addition to one or more of the features described above, or as an alternative, in further embodiments including a spin lock for selectively locking rotation of the child safety seat relative to the support base and at least one actuator operably coupled to the spin lock. The at least one actuator is operable to transform the spin lock between a locked position and an unlocked position.

In addition to one or more of the features described above, or as an alternative, in further embodiments the spin lock includes a plurality of lock pins and the support base includes a plurality of lock sections. The plurality of lock pins are engaged with the plurality of lock sections when the spin lock is in the locked position and the plurality of lock pins are disengaged from the plurality of lock sections when the spin lock is in the unlocked position.

In addition to one or more of the features described above, or as an alternative, in further embodiments the plurality of lock pins are operably coupled to one another by a connecting link.

In addition to one or more of the features described above, or as an alternative, in further embodiments the at least one actuator includes a handle and a tension member operably coupling the handle to one of the plurality of lock pins.

In addition to one or more of the features described above, or as an alternative, in further embodiments the at least one actuator is located at the seat back portion.

In addition to one or more of the features described above, or as an alternative, in further embodiments the plurality of lock pins includes a first lock pin and a second lock pin, the first lock pin having a different configuration than the second lock pin.

In addition to one or more of the features described above, or as an alternative, in further embodiments the second lock pin has a first section having an arcuate configuration and a second section having a rectangular configuration, the second section being coaxial with the first lock pin.

In addition to one or more of the features described above, or as an alternative, in further embodiments the seat back portion includes at least one impact pod. The at least one impact pod is arranged at a rear of the seat back portion.

In addition to one or more of the features described above, or as an alternative, in further embodiments the at least one impact pod substantially encircles the rear of the seat back portion.

In addition to one or more of the features described above, or as an alternative, in further embodiments when the child safety seat is in a forward-facing configuration. The at least one impact pod is vertically offset from the support base.

In addition to one or more of the features described above, or as an alternative, in further embodiments the seat pan portion includes a stability foot movable between a retracted position and an extended position.

In addition to one or more of the features described above, or as an alternative, in further embodiments a bottom of the stability foot is positionable in contact with the vehicle seat in the extended position.

In addition to one or more of the features described above, or as an alternative, in further embodiments the stability foot is biased to the extended position when the seat pan portion is separated from the support base.

In addition to one or more of the features described above, or as an alternative, in further embodiments including a retractor operably coupled to the stability foot. The stability foot is transformed to the retracted position in response to rotation of the retractor.

In addition to one or more of the features described above, or as an alternative, in further embodiments the seat pan portion includes a plurality of stability feet movable between a retracted position and an extended position. The plurality of stability feet are independently movable relative to the seat pan portion.

According to an embodiment, a child safety seat system positionable on a vehicle seat, the child safety seat system includes a support base and a child safety seat positionable on the support base. The child safety seat includes a booster seat removably couplable to the support base. The child safety seat is movable relative to at least a portion of the support base to adjust an incline of the child safety seat.

In addition to one or more of the features described above, or as an alternative, in further embodiments the child safety seat is rotatably positionable on the support base.

In addition to one or more of the features described above, or as an alternative, in further embodiments the booster seat includes a first booster portion and a second booster portion. The first booster portion is separable from the second booster portion.

In addition to one or more of the features described above, or as an alternative, in further embodiments the first booster portion is a seat back portion and the second booster portion is a seat pan portion of the child safety seat.

In addition to one or more of the features described above, or as an alternative, in further embodiments the first booster portion and the second booster portion are removably couplable from the support base. The first booster portion is separable from the support base independently from the second booster portion.

In addition to one or more of the features described above, or as an alternative, in further embodiments the support base includes a first base member and a second base member operably couplable to the child safety seat. The second base member is movable relative to the first base member to adjust the incline of the child safety seat.

In addition to one or more of the features described above, or as an alternative, in further embodiments a third base member is rotatable with the child safety seat relative to the second base member.

In addition to one or more of the features described above, or as an alternative, in further embodiments including a recline lock mechanism transformable between a locked position and an unlocked position. The recline lock mechanism is operable to selectively lock movement of the child safety seat at a position along a path of the incline.

In addition to one or more of the features described above, or as an alternative, in further embodiments the recline lock mechanism includes at least one recline pin and a plurality of lock openings. The at least one recline pin is engageable with a lock opening of the plurality of lock openings to lock the recline lock mechanism and the at least one recline pin being disengagable from the lock opening of the plurality of lock openings to unlock the recline lock mechanism.

In addition to one or more of the features described above, or as an alternative, in further embodiments the at least one recline pin includes a plurality of recline pins. The plurality of recline pins are operably coupled to one another by a pivot link.

In addition to one or more of the features described above, or as an alternative, in further embodiments including at least one actuator operably coupled to the recline lock mechanism. The at least one actuator is operable to transform the recline lock mechanism between the locked position and the unlocked position.

According to an embodiment, a child safety seat system positionable on a vehicle seat includes a support base and a child safety seat positionable on the support base. The child safety seat is rotatable relative to the support base between a rearward-facing configuration and a forward-facing configuration. When the child safety seat is in the forward-facing configuration, the child safety seat is translatable relative to the support base between plurality of forward-facing recline positions including a first forward-facing recline position and a second forward-facing recline position. The child safety seat is rotatable relative to the support base in either of the first forward-facing recline position and the second forward-facing recline position.

In addition to one or more of the features described above, or as an alternative, in further embodiments the child safety seat is selectively lockable in each of the first forward-facing recline position and the second forward-facing recline position.

In addition to one or more of the features described above, or as an alternative, in further embodiments the child safety seat is rotatable relative to the support base when the child safety seat is locked in the first forward-facing recline position and the second forward-facing recline position.

In addition to one or more of the features described above, or as an alternative, in further embodiments the support base includes a first base member and a second base member operably couplable to the child safety seat. The second base member is movable relative to the first base member to adjust a recline of the child safety seat between the first forward-facing recline position and the second forward-facing recline position.

In addition to one or more of the features described above, or as an alternative, further embodiments including a third base member rotatable with the child safety seat relative to the second base member.

In addition to one or more of the features described above, or as an alternative, in further embodiments the child safety seat is movable with the second base member and the third base member relative to the first base member to adjust the recline of the child safety seat between the first forward-facing recline position and the second forward-facing recline position.

In addition to one or more of the features described above, or as an alternative, in further embodiments the second base member includes a base anchor member and the third base member includes a seat anchor member. The base anchor member is connectable to the seat anchor member when the child safety seat is in the forward-facing configuration.

In addition to one or more of the features described above, or as an alternative, further embodiments including a recline lock mechanism transformable between a locked position and an unlocked position. The recline lock mechanism is operable to selectively lock the child safety seat at one of the plurality of forward-facing recline positions.

In addition to one or more of the features described above, or as an alternative, in further embodiments the recline lock mechanism includes at least one recline pin and a plurality of lock openings. The at least one recline pin is engageable with a lock opening of the plurality of lock openings to lock the recline lock mechanism and the at least one recline pin being disengagable from the lock opening of the plurality of lock openings to unlock the recline lock mechanism.

In addition to one or more of the features described above, or as an alternative, in further embodiments the at least one recline pin includes a plurality of recline pins. The plurality of recline pins being operably coupled to one another by a pivot link.

In addition to one or more of the features described above, or as an alternative, in further embodiments including at least one actuator operably coupled to the recline lock mechanism. The at least one actuator being operable to transform the recline lock mechanism between the locked position and the unlocked position.

In addition to one or more of the features described above, or as an alternative, in further embodiments the child safety seat includes a booster seat removably couplable to the support base.

In addition to one or more of the features described above, or as an alternative, in further embodiments the booster seat includes a first booster portion and a second booster portion. The first booster portion being separable from the second booster portion.

In addition to one or more of the features described above, or as an alternative, in further embodiments the first booster portion is a seat back portion and the second booster portion is a seat pan portion of the child safety seat.

In addition to one or more of the features described above, or as an alternative, in further embodiments the first booster portion is separable from the support base independently from the second booster portion.

According to an embodiment, a child safety seat system positionable on a vehicle seat includes a support base and a child safety seat rotatably positionable on the support base. The child safety seat includes a seat pan portion and a seat back portion. The seat pan portion is removably couplable to the support base via a booster locking mechanism. The booster locking mechanism includes a locking member selectively engageable with the support base to lock the seat pan portion to the support base.

In addition to one or more of the features described above, or as an alternative, in further embodiments the support base includes a first base member, second base member, and a third base member. The third base member is rotatable relative to the first base member.

In addition to one or more of the features described above, or as an alternative, in further embodiments the third base member further comprises a shaft and the locking member is selectively engageable with the shaft to lock the seat pan portion to the support base.

In addition to one or more of the features described above, or as an alternative, in further embodiments the locking member is selectively engageable with a bottom surface of the third base member.

In addition to one or more of the features described above, or as an alternative, in further embodiments including an actuator operably coupled to the locking member. The actuator is operable to transform the the locking member between a locked position in which the locking member is engaged with a portion of the support base and an unlocked position in which the locking member is separated from the portion of the support base.

In addition to one or more of the features described above, or as an alternative, in further embodiments the locking member includes an engagement member and an actuation member. The engagement member is selectively engageable with the support base to lock the seat pan portion to the support base. The actuation member is engageable with the actuator to release the seat pan portion from the support base.

In addition to one or more of the features described above, or as an alternative, in further embodiments the actuator is translatable into engagement with the actuation member.

In addition to one or more of the features described above, or as an alternative, in further embodiments the seat pan portion includes at least one seat side member and the actuator is located at the at least one seat side member.

In addition to one or more of the features described above, or as an alternative, in further embodiments the actuator is rotatable into engagement with the actuation member.

In addition to one or more of the features described above, or as an alternative, in further embodiments an axis of rotation of the actuator is parallel to an axis of the locking member.

In addition to one or more of the features described above, or as an alternative, in further embodiments the seat pan portion includes a seat support surface for receiving an occupant and the actuator is arranged at the seat support surface.

In addition to one or more of the features described above, or as an alternative, in further embodiments the actuator is movable between an unactuated position and an actuated position. The actuator is flush with the seat support surface when in the unactuated position.

According to an embodiment, a child safety seat system positionable on a vehicle seat includes a support base and a child safety seat positionable on the support base. The child safety seat includes a booster seat removably couplable to the support base. The booster seat includes a stability foot operable to adjust an incline of the booster seat relative to the vehicle seat.

In addition to one or more of the features described above, or as an alternative, in further embodiments the child safety seat is rotatable positionable on the support base.

In addition to one or more of the features described above, or as an alternative, in further embodiments the booster seat includes a first booster portion and a second booster portion. The first booster portion is separable from the second booster portion.

In addition to one or more of the features described above, or as an alternative, in further embodiments the first booster portion is a seat back portion and the second booster portion is a seat pan portion of the child safety seat.

In addition to one or more of the features described above, or as an alternative, in further embodiments the first booster portion is separable from the support base independently from the second booster portion.

In addition to one or more of the features described above, or as an alternative, in further embodiments the stability foot is movable between a stowed configuration and an extended configuration. The stability foot is receivable within the booster seat when in the stowed configuration.

In addition to one or more of the features described above, or as an alternative, in further embodiments the stability foot is automatically retractable to the stowed configuration in response to connecting the booster seat to the support base.

In addition to one or more of the features described above, or as an alternative, further embodiments including a biasing mechanism operably coupled to the stability foot. The stability foot is automatically biased to the extended configuration when the booster seat is separated from the support base.

A child safety seat system positionable on a vehicle seat includes a support base and a child safety seat positionable on the support base. The child safety seat includes a seat pan portion and a seat back portion. The seat pan portion and the seat back portion are removably couplable from the support base.

In addition to one or more of the features described above, or as an alternative, further embodiments the seat pan portion and the seat back portion are independently separable from the support base.

In addition to one or more of the features described above, or as an alternative, further embodiments the seat pan portion is removably couplable from the seat back portion.

In addition to one or more of the features described above, or as an alternative, further embodiments the seat back portion includes a seat back engagement feature and the seat pan portion includes a seat pan engagement feature. The seat back engagement feature is engageable with the seat pan engagement feature when the seat back portion and the seat pan portion are separated from the support base.

In addition to one or more of the features described above, or as an alternative, further embodiments one of the seat back engagement feature and the seat pan engagement feature is a protrusion and the other of the seat back engagement feature and the seat pan engagement feature is a recess. The protrusion is receivable within the recess to couple the seat back portion to the seat pan portion.

In addition to one or more of the features described above, or as an alternative, further embodiments the support base further includes a base member seat portion and a base member back portion. The seat pan portion is removably mountable to the base member seat portion and the seat back portion is removably mountable to the base member back portion.

In addition to one or more of the features described above, or as an alternative, further embodiments the base member back portion includes at least one base interlock feature and the seat back portion includes at least one seat interlock feature. The at least one base interlock feature is receivable within the at least one seat interlock feature to couple the seat back portion to the base member back portion.

In addition to one or more of the features described above, or as an alternative, further embodiments the seat pan portion is loosely positionable about the support base.

In addition to one or more of the features described above, or as an alternative, further embodiments the seat pan portion is removably couplable to the support base via a booster locking mechanism.

### BRIEF DESCRIPTION OF THE DRAWINGS

The following descriptions should not be considered limiting in any way. With reference to the accompanying drawings, like elements are numbered alike:

FIG. 1 is a side view of a child safety seat mounted to a vehicle seat in a toddler configuration according to an embodiment;

FIG. 2 is an exploded view of the child safety seat of FIG. 1 according to an embodiment;

FIG. 3 is a perspective view of a portion of the support base of a child safety seat in a forward-facing configuration according to an embodiment;

FIG. 4 is a perspective view of a portion of the support base of a child safety seat in a rearward-facing configuration according to an embodiment;

FIG. 5 is a perspective view of a child safety seat having a seat pan portion of a child safety seat separated from a support base according to an embodiment;

FIG. 6 is a perspective view of a child safety seat and a bottom perspective view of a seat pan portion of a child safety seat separated from a support base according to an embodiment;

FIG. 7 is a front perspective view of a child safety seat and a bottom view of a seat pan portion of a child safety seat separated from a support base according to an embodiment;

FIG. 8 is a perspective view of a child safety seat having a child safety seat separated from a support base according to an embodiment;

FIG. 9 is a perspective view of a child safety seat mounted to a support base in a toddler configuration according to an embodiment;

FIG. 10 is an exploded rear perspective view of a child safety seat and a portion of a support base of a child seat according to an embodiment;

FIG. 11 is a rear view of a child safety seat mounted to a portion of a support base of a child seat according to an embodiment;

FIG. 12 is a cross-sectional view of an interface between a child safety seat and a portion of a support base taken along line 12-12 of FIG. 11 according to an embodiment;

FIG. 13A is a front perspective view of an engagement feature of a child safety seat in an unlocked position according to an embodiment;

FIG. 13B is a front view of an engagement feature of a child safety seat in a locked position according to an embodiment;

FIG. 14 is an exploded rear perspective view of a child safety seat and a portion of a support base of a child seat according to an embodiment;

FIG. 15 is a perspective view of an interface between a child safety seat and a portion of a support base of a child seat according to an embodiment;

FIG. 16 is a side view of a child safety seat in an infant configuration according to an embodiment;

FIG. 17 is a side view of a child safety seat in a toddler configuration according to an embodiment;

FIG. 18 is a side view of a child safety seat in a high back booster configuration according to an embodiment;

FIG. 19 is a side view of a child safety seat in a backless booster configuration according to an embodiment; and

FIG. 20A is a rear perspective view of an interface between a first booster portion and a second booster portion according to an embodiment;

FIG. 20B is a front perspective view of an interface between a first booster portion and a second booster portion according to an embodiment;

FIG. 21A is a perspective view of a child safety seat system according to an embodiment;

FIG. 21B is a side view of the child safety seat system of FIG. 21A positioned about a vehicle seat according to an embodiment;

FIG. 21C is a front of the child safety seat system of FIG. 21A according to an embodiment

FIG. 22 is an exploded perspective view of a seat back portion and part of the support base according to an embodiment;

FIG. 23 is a rear perspective view of the child safety seat of FIG. 21A according to an embodiment;

FIGS. 24A, 24B, and 24C are various views of a headrest according to an embodiment;

FIG. 25 is a side view of a portion of the support base of a child safety seat in a forward-facing configuration according to an embodiment;

FIG. 26 is a perspective view of a portion of a third base member of a support base according to an embodiment;

FIG. 27 is perspective view of an interface between a seat back portion and part of a third base member of a support base according to an embodiment;

FIG. 28A is a perspective view of a spin lock in a locked position according to an embodiment;

FIG. 28B is a perspective view of a spin lock in an unlocked position according to an embodiment;

FIG. 29 is a perspective view of a connection between an actuator and the locking pins of a spin lock according to an embodiment;

FIG. 30 is a perspective view of an actuator associated with the spin lock according to an embodiment;

FIG. 31 is an exploded perspective view of the actuator associated with the spin lock of FIG. 30 according to an embodiment;

FIG. 32A is a side view of the actuator of FIG. 31 in an unactuated position according to an embodiment;

FIG. 32B is a side view of the actuator of FIG. 31 in an actuated position according to an embodiment;

FIG. 33 is a side view of the child safety seat system having the seat pan portion separated therefrom according to an embodiment;

FIG. 34 is a cross-sectional view of a booster locking mechanism according to an embodiment;

FIG. 35 is a perspective view of an actuator associated with the booster locking mechanism of FIG. 34 according to an embodiment;

FIG. 36A is a perspective view of a seat pan portion having a stability foot in a retracted position according to an embodiment;

FIG. 36B is a perspective view of a seat pan portion having a stability foot in an extended position according to an embodiment;

FIG. 37A is a side view of the seat pan portion of FIG. 36A according to an embodiment;

FIG. 37B is a side view of the seat pan portion of FIG. 36B according to an embodiment;

FIG. 38 is a cross-sectional view of a child safety seat system according to an embodiment;

FIG. 39A is a plan view of a spin lock in a locked configuration according to an embodiment;

FIG. 39B is a plan view of a spin lock according in an unlocked configuration according to an embodiment;

FIG. 40 is a side view of a child seat including an actuator associated with a spin lock according to an embodiment;

FIG. 41 is a perspective view of a recline lock mechanism according to an embodiment;

FIG. 42 is a detailed view of a portion of a recline lock mechanism according to an embodiment;

FIG. 43A is a perspective view of a recline lock mechanism according in a locked configuration according to an embodiment;

FIG. 43B is a perspective view of a recline lock mechanism according in an unlocked configuration according to an embodiment;

FIG. 44A is a cross-sectional view of an actuator operably coupled to a recline lock mechanism in a locked configuration according to an embodiment;

FIG. 44B is a cross-sectional view of an actuator operably coupled to a recline lock mechanism in an unlocked configuration according to an embodiment;

FIG. 45 is a perspective view of a belt tensioner of a support base in an open position according to an embodiment;

FIG. 46 is a detailed perspective view of a belt tensioner lock mechanism according to an embodiment;

FIG. 47 is a perspective view of a front of a belt tensioner according to an embodiment;

FIG. 48 is a perspective view of a seat pan portion of a child seat according to an embodiment;

FIG. 49A is a cross-sectional view of a booster locking mechanism of a seat pan portion in a locked configuration according to an embodiment;

FIG. 49B is a cross-sectional view of a booster locking mechanism of a seat pan portion in an unlocked configuration according to an embodiment;

FIG. 50 is a perspective view of a seat pan portion of a child seat including a removable cup holder according to an embodiment;

FIG. 51 is a side view of a cup holder separated from the seat pan portion according to an embodiment;

FIG. 52 is a cross-sectional view of the cup holder of FIG. 51 connected to the seat pan portion according to an embodiment;

FIG. 53 is a perspective view of a seat pan portion including multiple stability feet according to an embodiment;

FIG. 54 is a side view of a retractor operably coupled to a stability foot according to an embodiment;

FIG. 55A is a side view of a seat pan portion having a stability foot in an extended configuration according to an embodiment;

FIG. 55B is a side view of the seat pan portion of FIG. 55A with a stability foot in a retracted configuration according to an embodiment;

FIG. 56 is a plan view of a seat pan portion including a plurality of stability feet in a retracted configuration according to an embodiment;

FIG. 57 is a plan view of part of seat pan portion engaged with a booster receiver according to an embodiment;

FIG. 58 is a side view of a retractor operably coupled to a stability foot according to another embodiment;

FIG. 59A is a side view of a stability foot in an extended configuration according to an embodiment;

FIG. 59B is a side view of the stability foot of FIG. 59A in a retracted configuration according to an embodiment;

FIG. 60A is a side view of a structural frame of a support base of the child safety seat system according to an embodiment;

FIG. 60B is a perspective view of a structural frame of a support base of the child safety seat system according to an embodiment;

FIG. 61 is a rear perspective view of a locking mechanism of a headrest according to an embodiment;

FIG. 62A is a side view of a locking mechanism of a headrest according to an embodiment;

FIG. 62B is a perspective view of the locking mechanism of FIG. 62A according to an embodiment;

FIG. 63A is a perspective view of a locking mechanism of a headrest in a locked configuration according to an embodiment;

FIG. 63B is a perspective view of the locking mechanism of FIG. 63A in an unlocked configuration according to an embodiment

FIG. 64A is a side perspective view of a locking mechanism of a headrest in a locked configuration according to an embodiment;

FIG. 64B is a side perspective view of the locking mechanism of FIG. 64A in an unlocked configuration according to an embodiment

FIG. 65 is a perspective view of a locking mechanism of a headrest according to another embodiment;

FIG. 66A is a perspective view of the locking mechanism of FIG. 65 according to an embodiment;

FIG. 66B is another perspective view of the locking mechanism of FIG. 65 according to an embodiment;

FIG. 67A is a back view of a headrest including the locking mechanism of FIG. 65 in a locked position according to an embodiment;

FIG. 67B is a back view of a headrest including the locking mechanism of FIG. 65 in an unlocked position according to an embodiment;

FIG. 68A is a side view of the headrest of FIGS. 67A-67B having a locking mechanism in a locked position according to an embodiment;

FIG. 68B is a side view of the headrest of FIGS. 67A-67B having a locking mechanism in an unlocked position according to an embodiment;

FIG. 69A is a sectional perspective view of a headrest having a locking mechanism in a locked position according to an embodiment;

FIG. 69B is a sectional perspective view of a headrest having a locking mechanism in an unlocked position according to an embodiment;

FIG. 70 is a perspective view of a storage compartment formed in a support base of a child safety seat system according to an embodiment;

FIG. 71A is a plan view of a spin lock in a locked configuration according to an embodiment;

FIG. 71B is a plan view of a spin lock according in an unlocked configuration according to an embodiment;

FIG. 72 is a plan view of the spin lock of FIGS. 71A and 71B separated from the child seat according to an embodiment;

FIG. 73 is a side view of a seat pan portion having an actuation mechanism associated with a removably cupholder according to an embodiment;

FIG. 74 is a side view of a removable cup holder according to an embodiment;

FIG. 75A is a cross-sectional view of a seat pan portion including an actuation mechanism for selectively coupling a cup holder to the seat pan portion in an engaged position according to an embodiment; and

FIG. 75B is a cross-sectional view of a seat pan portion including an actuation mechanism for selectively coupling a cup holder to the seat pan portion in a disengaged position according to an embodiment.

### DETAILED DESCRIPTION

A detailed description of one or more embodiments of the disclosed apparatus and method are presented herein by way of exemplification and not limitation with reference to the Figures.

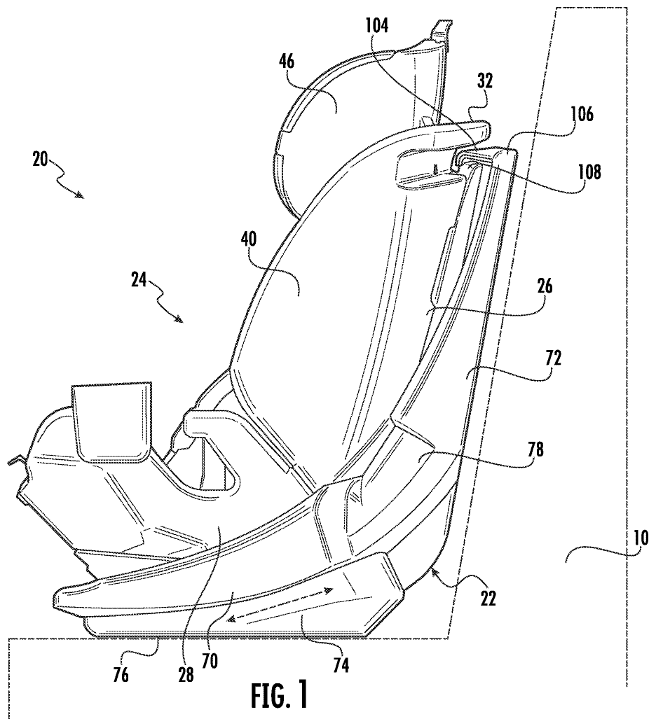

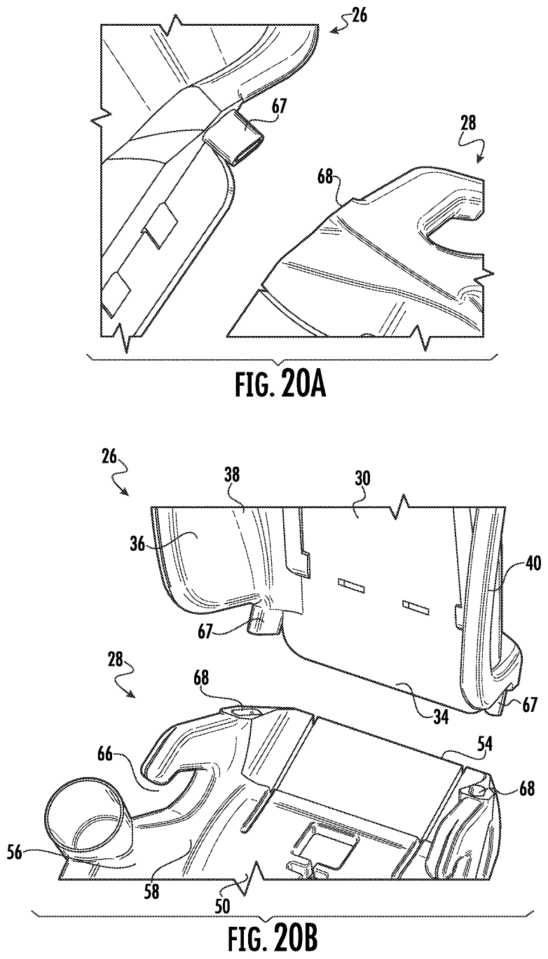

With reference now to the FIGS., various examples of a child safety seat system 20 are illustrated. In each of the illustrated, non-limiting embodiments, the child safety seat system 20 includes a support base 22 that can be detachably fixed to a vehicle seat 10 (see FIGS. 1 and 20), such as via a latch or anchor mechanism, not shown in the FIGS. This latch or anchor system often used is sometimes referred to as a “lower anchor and tether for children” e.g., LATCH system. Alternatively, or in addition, the support base 22 may be detachably fixed to a vehicle seat 10 via a vehicle belt associated with the vehicle seat 10.

The child safety seat system 20 additionally includes a child safety seat 24 associated with the support base 22. In an embodiment, the child safety seat 24 is detachably coupled to the support base 22, thereby allowing the child safety seat 24 to be separated from the support base 22. Alternatively, the support base 22 and at least a portion of the child safety seat 24 may be permanently connected or affixed together, as will be described in more detail below. As used herein the term “permanently connected” identifies embodiments where the child safety seat 24 or a portion thereof is not intended to be disassembled from the support base 22 by a user.

The child safety seat 24 includes a seat back portion 26 and a seat pan portion 28 arranged at an angle relative to the seat back portion 26. The seat pan portion 28 may but need not be configured to removably couple to the seat back portion 26. In the illustrated, non-limiting embodiments, the seat back portion 26 includes a seat back having an upright support surface 30 generally facing forward and that extends from a first end or top 32 of the seat back portion 26 to a second, opposite end or bottom 34 of the seat back portion 26. A first upright side member 36 may be arranged at a first side 38 of the upright support surface 30 and a second upright side member 40 may be arranged at a second, opposite side 42 of the upright support surface 30. The first and second upright side members 36, 40 therefore form the left side and the right side of the seat back portion 26, respectively. As shown, the first and second upright side members 36, 40 extend forward from the upright support surface 30. The first and second upright side members 36, 40 may extend generally orthogonally to the upright support surface 30 or alternatively, may extend therefrom at another angle, such as an angle greater than 90° for example. Accordingly, the upright support surface 30 and the first and second upright side members 36, 40 define a backrest region or upright support cavity within which an upper body of a child is received.

The upright side members 36, 40 may facilitate the correct positioning of a vehicle belt during one or more modes of operation when the child safety seat 24 is installed within a vehicle. Although not shown, in some embodiments, each upright side member 36, 40 has an opening formed therein. The openings may be configured to receive a vehicle belt (not shown) to secure the child safety seat 24 to a vehicle seat 10 in a forward-facing configuration or to secure an upper body of a child located within the cavity.

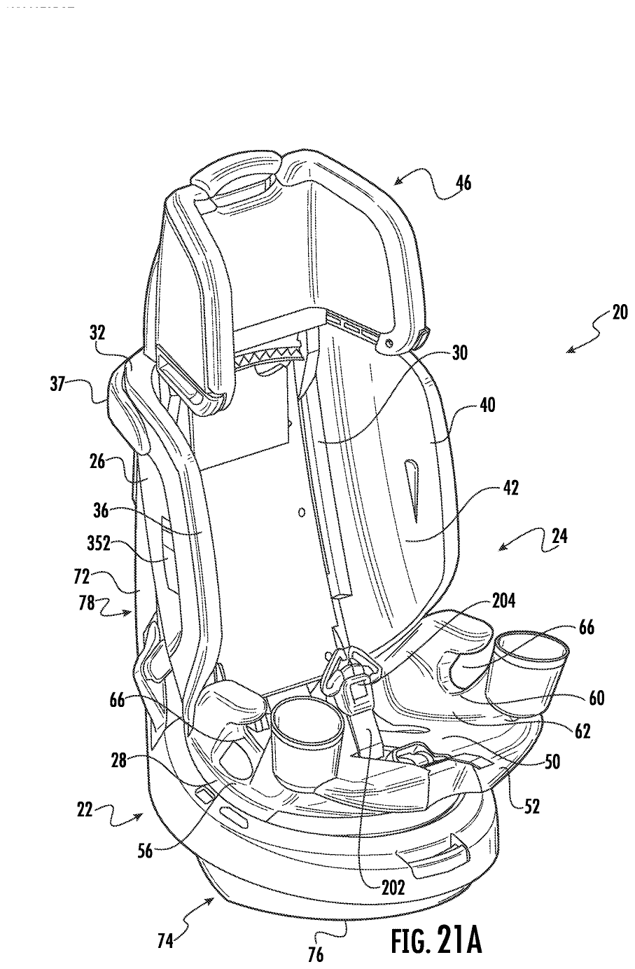

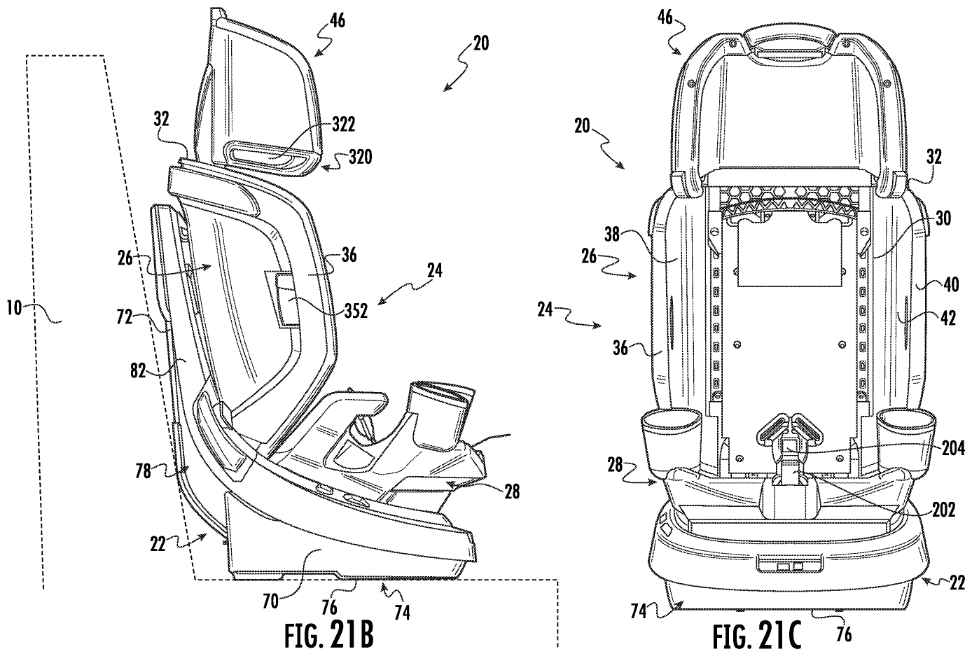

In the non-limiting embodiment illustrated in FIGS. 21A-23, the seat back portion 26 is an assembly including a seat back 27, with the upright support surface 30 and the first and second upright side members 36, 40 extending at an angle therefrom as previously described. A separate back cover or seat back shell 29 may be positioned in contact with a rearward-facing surface 31 of the seat back 27. In the illustrated, non-limiting embodiment, the seat back shell 29 has a size and shape complementary to the seat back 27 such that the seat back shell 29 overlaps the entire rearward-facing surface 31 of the seat back 27. However, embodiments where the seat back shell 29 has a configuration that covers only a portion of the rearward-facing surface 31 of the seat back 27 is also within the scope of the disclosure. In such embodiments, the seat back shell 29 is formed from a first material, such as a plastic or a composite for example, and the seat back 27 may be formed from a different second material, such as a polystyrene or high-density foam for example Further, soft goods (not shown) may be affixed to the inwardly facing surface of the seat back 27 to provide cushioning for a child arranged within the backrest region.

With continued reference to FIGS. 21A-23, in the illustrated, non-limiting embodiment, a seat back panel 33 is mounted in overlapping arrangement with the upright support surface 30 of the seat back 27. The seat back panel 33 may have a configuration complementary to the upright support surface 30. As shown, the seat back panel 33 is generally rectangular and includes a length approximately equal to the distance between the top 32 and bottom 34 of the upright support surface 30 and a width generally equal to the distance between the first side 38 and the second side 42 of the upright support surface 30. In other embodiments, the seat back panel 33 may cover only a portion of the upright support surface 30, or alternatively, may extend beyond the upright support surface 30, such as in overlapping arrangement with one or both of the first and second upright side members 36, 40 for example.

Regardless of the construction of the seat back portion 26, in a non-limiting embodiment, one or more bumpers or side impact pods 37 designed to absorb forces in the event of an accident or crash may be arranged at an exterior surface 35 of the seat back portion 26. Although a single impact pod 37 is illustrated in the FIGS. 21A-23, it should be appreciated that embodiments having a plurality of impact pods 37 are within the scope of the disclosure. As shown, the at least one impact pod 37 may be arranged near the top 32 of the seat back portion 26. In an embodiment, the at least one impact pod 37 may be arranged at a location positioned vertically above the support base 22, such as when the child safety seat 24 is in a forward-facing configuration. Further, the at least one impact pod is not arranged in contact with a vehicle seat 10 when the child safety seat system 20 is installed about a vehicle seat 10. However, embodiments including an impact pod 37 arranged alternatively or additionally at another location are also contemplated herein. In the illustrated, non-limiting embodiment, an impact pod 37 is arranged generally centrally and extends or wraps about the exterior surface 35 towards at least one, and in some embodiments, both the first upright side member 36 and the second upright side member 40. Accordingly, the at least one impact pod 37 may substantially encircle the rear of the seat back portion 26. However, it should be appreciated that embodiments where one or more impact pads 37 are positioned solely at the center of the seat back portion, such as generally aligned with the upright support surface 30 for example, or solely at a side of the exterior surface, such as in alignment with one of the upright side members 36, 40, are also contemplated herein.

In the illustrated, non-limiting embodiments, the seat back portion 26 of the child safety seat 24 includes a headrest 46. The headrest 46 may be attached to or integral with the seat back portion 26 or may be removably coupled thereto. The headrest 46 may be stationary, or in some embodiments, may be configured to move relative to the upright support surface 30. For example, the headrest 46 may be configured to translate relative to the upright support surface 30 between a retracted position and an extended position, allowing for adjustment based on the size of the child positioned within the child safety seat 24. However, it should be appreciated that embodiments where the seat back portion 26 does not include a headrest 46 are also contemplated herein.

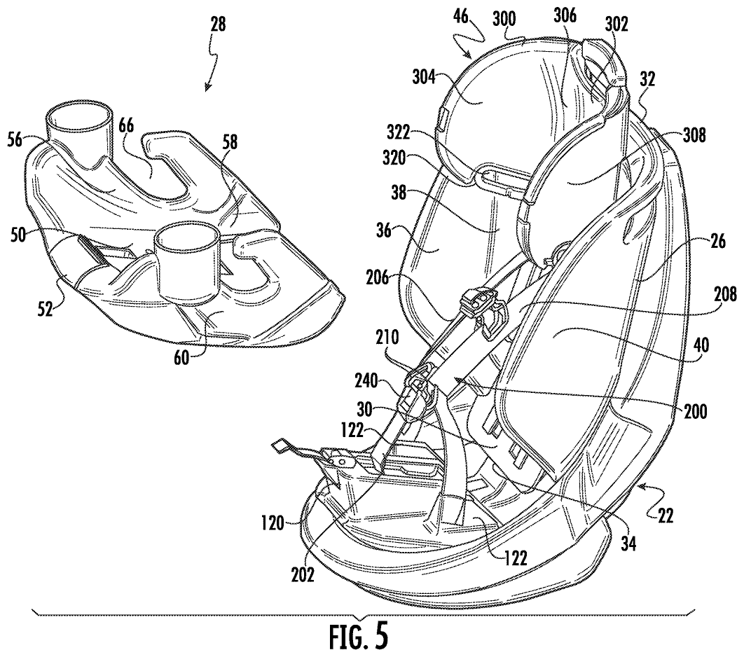

With reference to FIGS. 5, 6, and 24A-24C, in an embodiment, the headrest 46 includes a main body, identified at 300, having a head support surface 302. A first head side member 304 may be arranged at a first side 306 of the head support surface 302 and a second head side member 308 may be arranged at a second, opposite side 310 of the head support surface 302. The first and second head side members 304, 308 form a respective left side and right side of the headrest 46. The first and second head side members 304, 308 extend forward from the head support surface 302. Accordingly, the head support surface 302 and the first and second head side members 304, 308 define a headrest region or cavity within which the head of a child positioned within the child safety seat 24 is received. The first and second head side members 304, 308 may extend generally orthogonally to the head support surface 302 or alternatively, may extend therefrom at another angle, such as an angle greater than 90° for example. The angle of at least one of the first and second head side members 304, 308 relative to the head support surface 302 may be equal or may be different than the angle of a corresponding one of the first and second upright side member 36, 40 relative to the upright support surface 30.

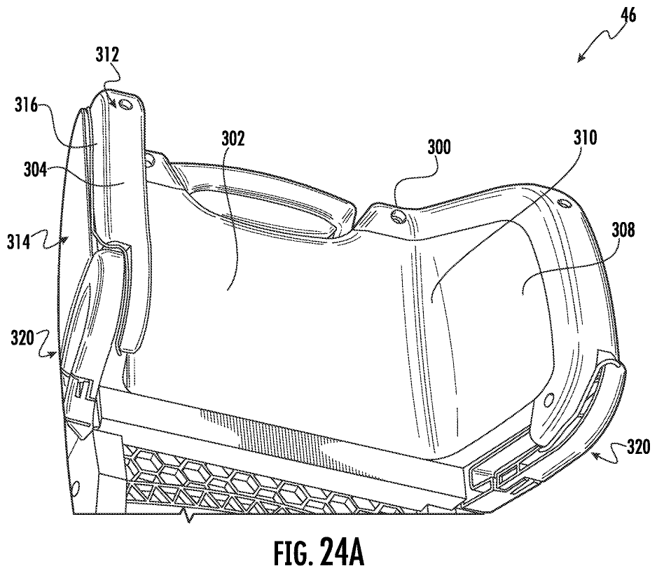

In an embodiment, as shown in FIGS. 24A-24C, the main body of the headrest 46 is an assembly including a first portion 312 having the head support surface 302 and the first and second head side members 304, 308 extending at an angle therefrom as described. A second portion 314 including a headrest cover or panel may be positioned in contact with a rearward-facing surface (not shown) of the first portion 312. In the illustrated, non-limiting embodiment, the second portion 314 has a size and shape complementary to the first portion 312 such that the second portion 314 substantially overlaps the entire rearward-facing surface of the first portion 312. In such embodiments, the second portion 314 may be a structural shell formed from a first material, such as a plastic for example, and the first portion 312 may be formed from a different second material, such as a polystyrene or high-density foam for example. Soft goods (not shown) may be arranged at one or more surfaces of the first portion 312 facing the headrest region to provide cushioning for a child arranged within the child safety seat 24. In an embodiment, a channel 316 is formed between the first portion 312 and the second portion 314 and a portion of the soft goods is arranged within the channel 316 to couple the soft goods to the headrest 46. However, any suitable means for attaching soft goods to a headrest 46 is contemplated herein.

The headrest 46 may include at least one shoulder belt guide 320 having an opening 322 for receiving a vehicle belt therein. The shoulder belt guide 320 may be integrally formed with the body of the headrest, or alternatively, may be a separate component affixed thereto. As shown in FIGS. 24A-24C, the at least one shoulder belt guide 320 may be mounted in alignment with and as an extension of a portion of the main body 300. For example, at least one shoulder belt guide 320 can be positioned at the bottom surface of one or both of the first and second head side members 304, 308. The shoulder belt guide 320 may have a shape complementary to the adjacent portion of the main body 300 such that the shoulder belt guide is flush with the main body and defines a portion of the contour of the headrest 46. The at least one shoulder belt guide 320 may be permanently affixed to the main body 300, or alternatively, may be removably couplable thereto. In the illustrated, non-limiting embodiment, the shoulder belt guide 320 is attached to the main body 300, such as at a position between the first portion 312 and the second portion 314 for example, using one or more fasteners. However, it should be appreciated that any suitable means for removably connecting the shoulder belt guide 320 to the main body 300 of headrest 46 at any location is within the scope of the disclosure.

The seat pan portion 28 of the child safety seat 24 may include a seat support surface 50 facing generally upwardly and that extends from a first end or front 52 to a second end or back 54 of the seat pan portion 28. A first seat side member 56 may be arranged at a first side 58 of the seat support surface 50 and a second seat side member 60 may be arranged at a second, opposite side 62 of the seat support surface 50. The first seat side member 56 and the second seat side member 60 extend upwardly and from the left side and the right side of the seat portion. The seat support surface 50 and the first and second seat side members 56, 60 in combination define a region within which at least part of a lower body of a child may be received.

As shown, the seat side members 56, 60 extend at an angle from the seat support surface 50. The angle of the first seat side member 56 relative to the seat support surface 50 may but need not be the same as the angle of the first upright side member 36 relative to the upright support surface 30. Similarly, the angle of the second seat side member 60 relative to the seat support surface 50 may but need not be the same as the angle of the second upright side member 40 relative to the upright support surface 30.

In the illustrated, non-limiting embodiment, each seat side member 56, 60 has a slot 66 formed therein configured to function as a lap belt guide during at least one mode of use of the child safety seat 24. In some modes of operation of the child safety seat 24, the slot 66 may be configured to receive and position a lap belt portion of a vehicle restraint or a separate restraint belt to secure a child within the child safety seat 24. As will be described in more detail below, a rotational configuration and/or an incline of the child safety seat 24 may be adjusted when the child safety seat 24 is connected to the support base 22.

The child safety seat 24 generally includes a first booster portion and a second booster portion, and in an embodiment, the seat back portion 26 may be considered the first booster portion and the seat pan portion 28 may be considered the second booster portion. However, embodiments where the seat pan portion 28 is the first booster portion and the seat back portion 26 is the second booster portion are also contemplated herein. The first booster portion may but need not be configured to removably couple to the second booster portion. In the non-limiting embodiment illustrated in FIGS. 20A and 20B, the seat back portion 26 includes at least one seat back engagement feature 67 and the seat pan portion 28 includes at least one seat pan engagement feature 68 selectively engageable with a corresponding seat back engagement feature. As shown, the seat back engagement feature 67 may be a protrusion extending from near the second end 34, and the seat pan engagement feature 68 may be a corresponding recess or opening formed in a surface of the seat pan portion 28 and aligned with the protrusion. Accordingly, the protrusion is receivable within the recess to couple the seat back portion 26 to the seat pan portion 28. However, embodiments where the seat pan engagement feature 68 is a protrusion and the seat back engagement feature 67 is a recess are also contemplated herein. Further, other suitable mechanisms for removably coupling the seat back portion 26 to the seat pan portion 28 are also within the scope of the disclosure.

The support base 22 for mounting the child safety seat 24 includes a base body having a base seat portion 70 and a base back portion 72 (see FIG. 1). Suitable materials for making the base body include but are not limited to rigid plastic or composite materials for example. The base seat portion 70 and the base back portion 72 may be integrally formed as a unitary body, or alternatively, may be formed by separate components removably or permanently connected together.

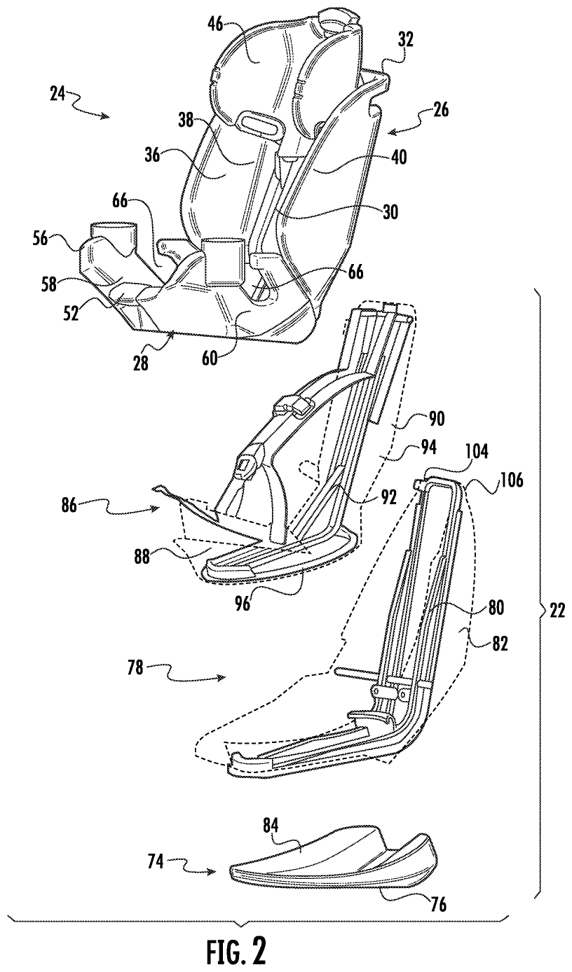

With reference now to FIG. 2, in the illustrated, non-limiting embodiment, the support base 22 includes a first base member 74, having a bottom surface 76 suitable for placement on a support surface, such as the vehicle seat 10 for example, and a second base member 78 coupled to the first base member 74. The first base member 74 may be a recline foot and/or the second base member 78 may include a rigid frame 80 at least partially contained within a structural shell 82. At least a portion of the second base member 78 may be positioned in overlapping arrangement with an upper surface 84 of the first base member 74. In the non-limiting embodiments shown in the FIGS., the first base member 74 is arranged solely at the base seat portion 70 of the support base 22 and the second base member 78 forms a portion of both the base back portion 72 and the base seat portion 70. However, embodiments where the first base member 74 forms a portion of both the base back portion 72 and the base seat portion 70 are also contemplated herein. With reference to the FIGS., in an embodiment, the support base 22 includes a third base member 86, such as a spin member for example, positioned in overlapping arrangement with the second base member 78. The third base member 86 includes a base member seat portion 88 located at the base seat portion 70 of the support base 22 and may include a base member back portion 90 extending from the base member seat portion 88 at an angle. As will be described in more detail below, at least a portion of the child safety seat 24 is removably couplable to the third base member 86 of the support base 22.

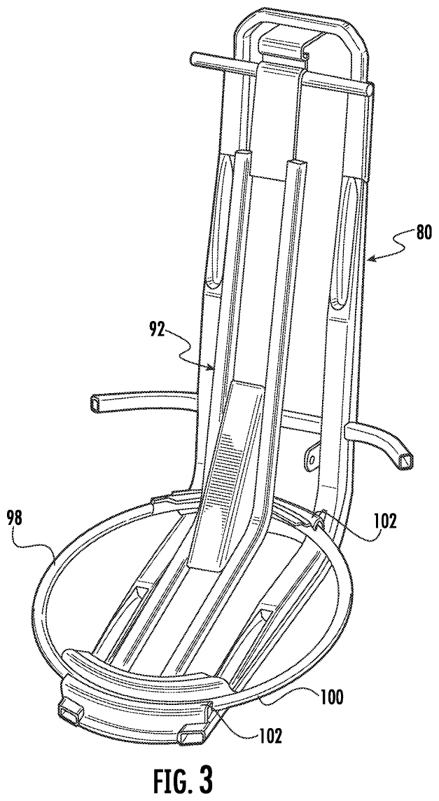

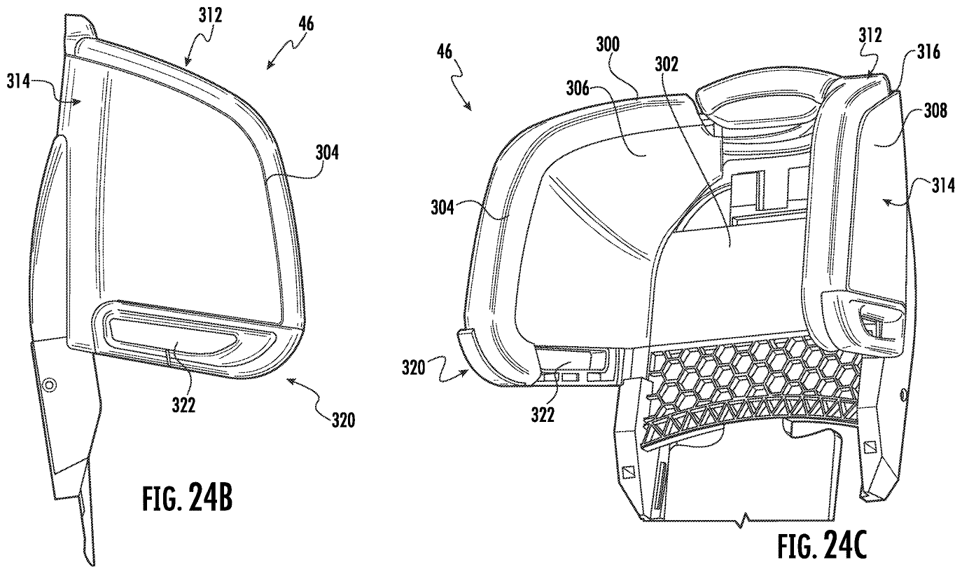

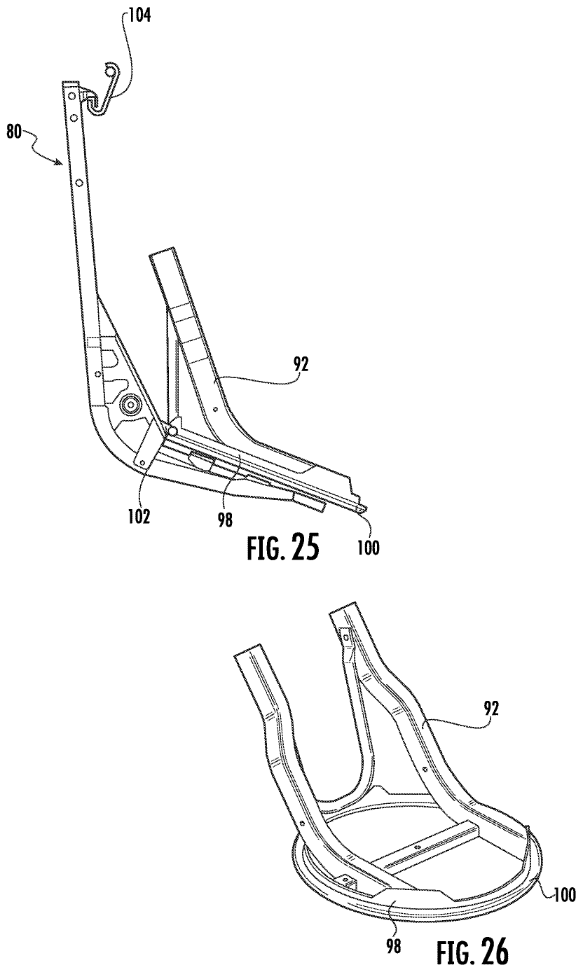

The third base member 86, and therefore any portion of the child safety seat 24 coupled to the third base member 86, may be rotatable about an axis relative to first and second base members 74, 78. In an embodiment, the third base member 86 includes a spin carriage 92. The spin carriage 92 may have varying configurations as shown in FIGS. 2, 3, 25, and 26. In the non-limiting embodiment shown in FIGS. 2 and 3, the spin carriage 92 is at least partially contained within a structural shell or body 94. However, embodiments that do not include a body 94 are also contemplated herein. For example, in an embodiment shown in FIGS. 25-27, the base member back portion 90 and a distal end of the spin carriage 92 may be positioned between the seat back panel 33 and the seat back, such as the upright support surface 30 for example. The seat back panel 33 may include a protrusion or tab 96 insertable into a corresponding recess or opening (not shown) formed in the base member seat portion 88 to couple the third base member to the seat back portion 26.

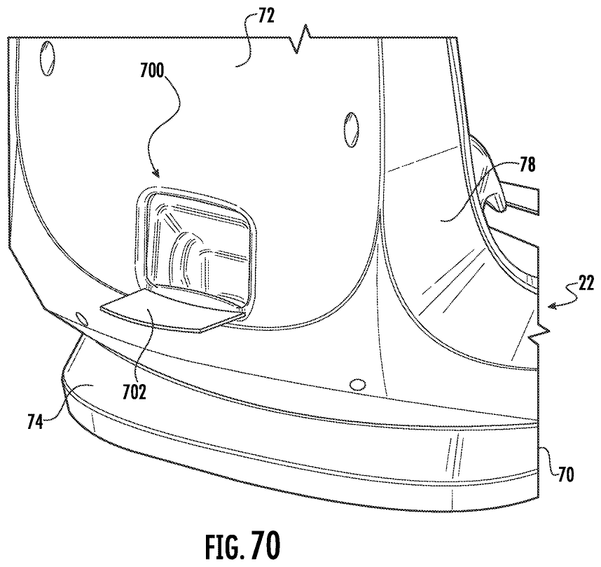

With reference to FIG. 70, a storage compartment 700 may be formed in a portion of the support base 22, such as at the base back portion 72 for example. The storage compartment 700 is generally illustrated as being formed solely in the second base member 78, though embodiments where the storage compartment 700 is formed solely in the first base member 74, or alternatively, formed by the first and second base members 74, 78 in combination, are also within the scope of the disclosure. In an embodiment, one or more latches (not shown) for affixing the child seat system 20 to a vehicle seat, such as of a LATCH system for example, may be retained within the storage compartment 700. As shown, a cover 702 may be movable relative to the support base 22 between an open position and a closed position (not shown) to selectively seal the storage compartment 700. In an embodiment, the cover 702 is removable from the support base 22. However, in other embodiments, the cover 702 may be movably coupled, for example pivotably or hingedly coupled, to the support base 22 such that the cover 702 remains affixed to the support base when the cover 504 is both the open and closed positions.

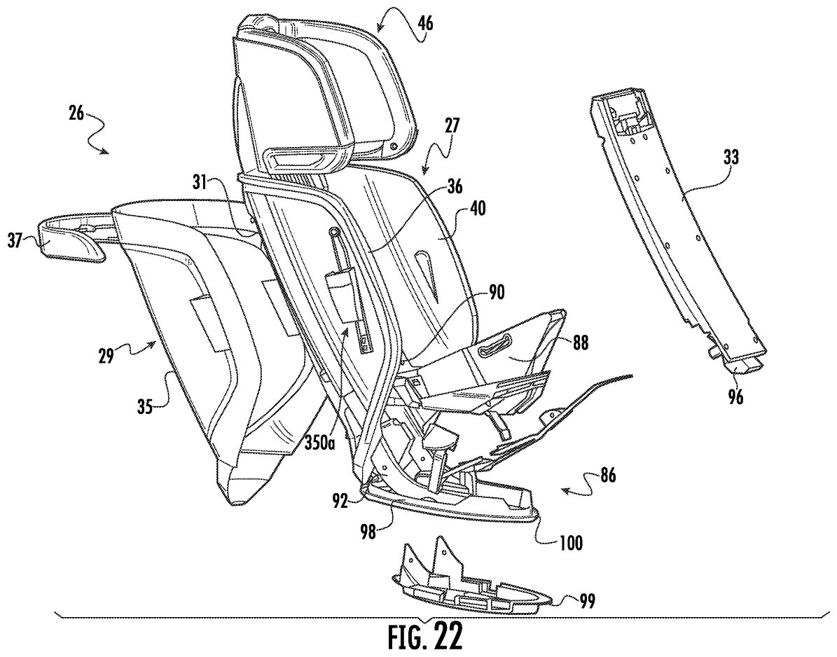

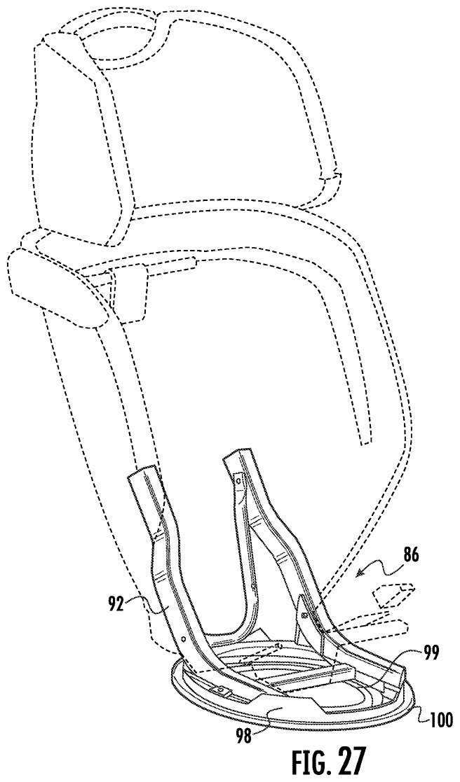

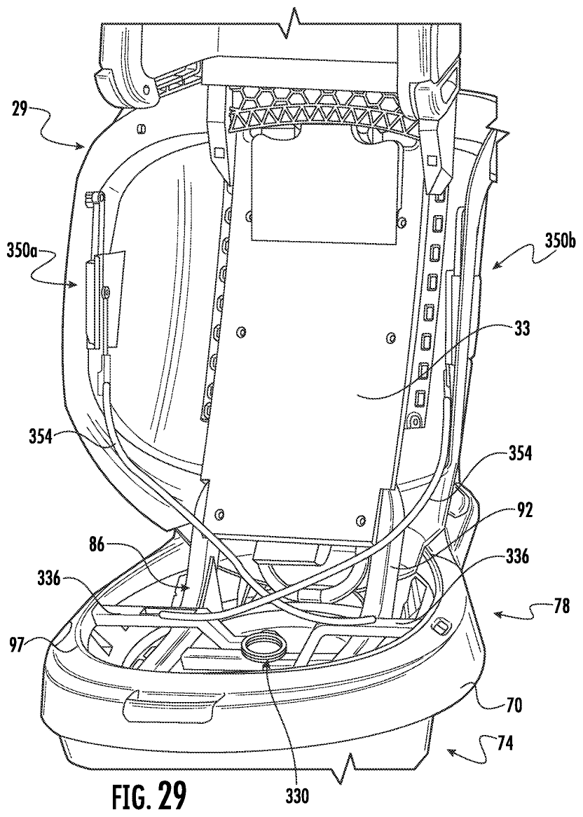

The second base member 78 at the base seat portion 70 may include a contour or opening 97 (see FIG. 29) and a portion of the third base member 86 may be receivable within the opening 97. In an embodiment, shown in FIGS. 3, 4, and 25-27, near a bottom of the third base member 86, the spin carriage 92 includes a circular flange 98, for example having an edge rolled or otherwise shaped to form a seat anchor or lip 100. A portion of the second base member 78, such as the rigid frame 80 for example, may include one or more hooks or anchors 102 (see FIGS. 3 and 25) having a curvature configured to engage the lip 100. In some embodiments, such as shown in FIGS. 22 and 27, a bottom spin cover 99 may be positioned vertically beneath the circular flange 98. In such embodiments, the bottom spin cover 99 may but need not be mounted to the circular flange 98.

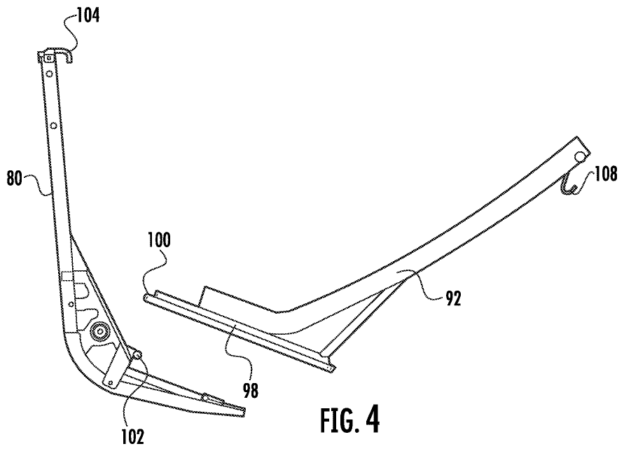

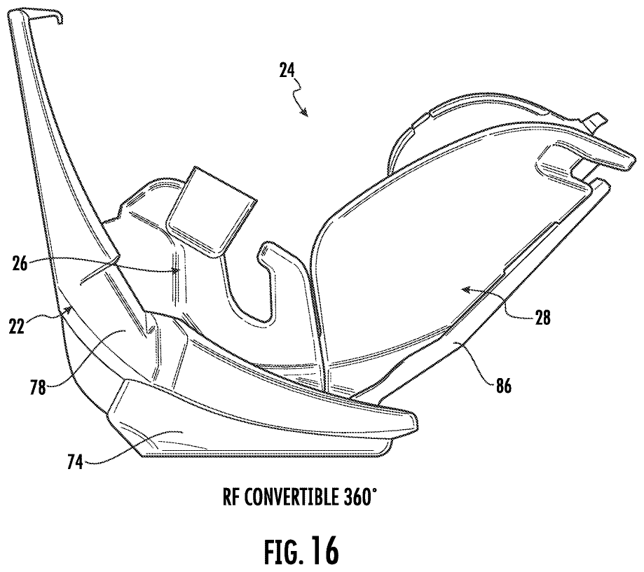

In an embodiment, the third base member 86 is rotatable about an axis relative to the first and second base members 74, 78 of the support base 22 between a plurality of configurations. In an embodiment, the third base member 86, and therefore a child safety seat 24 connectable to the third base member 86, is rotatable relative to both the first and second base members 74, 78 of the support base 22. For example, the engagement between the lip 100 and the corresponding hook 102 formed on the second base member 78 may define a path of rotation of the third base member 86 relative to the first and second base members 74, 78, and therefore a path of rotation of the child safety seat 24 relative to the support base 22. As shown in FIGS. 4, 16, and 17, the third base member 86, and therefore the child safety seat 24 connectable to the third base member 86 is rotatable between a first rotational configuration, such as a configuration in which the child safety seat 24 is in a forward-facing position (FIGS. 1 and 3), and a second rotational configuration, such as a configuration in which a child safety seat 24 is in a rearward-facing position (FIGS. 4 and 16). However, it should be appreciated that embodiments where the child safety seat 24 is positionable in one or more additional configurations between the first rotational configuration and a second rotational configuration are also within the scope of the disclosure.

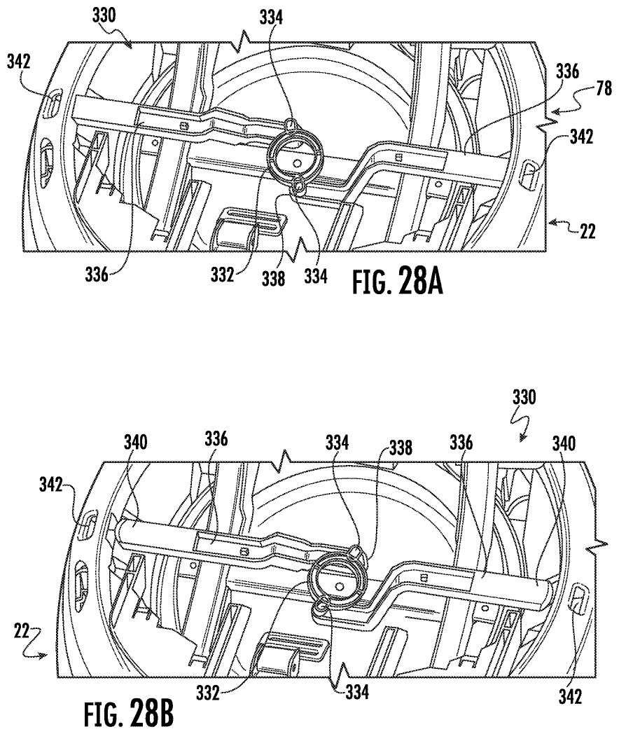

A spin lock 330 may be used to selectively lock rotation of the third base member 86, and therefore the child safety seat 24 coupled to the third base member 86, at one of the plurality of configurations relative to the support base 22. With reference to FIGS. 28A and 28B an example of spin lock 330 is illustrated in more detail. As shown, the spin lock 330 is arranged within the portion of the second base member 78 at the base seat portion 70 of the support base 22. With reference to the illustrated, non-limiting embodiment, the spin lock 330 includes a centrally positioned connecting link 332 that is rotatable about an axis X. In an embodiment, the connecting link 332 may be suitably mounted to the support base 22 via a bolt or other suitable fastener. As shown, the connecting link 332 may have two end segments 334 extending outwardly therefrom, such as disposed on opposite sides of the connecting link 332 relative to axis of rotation. A plurality of lock pins 336, such as two lock pins for example, are connected to the connecting link 332. For example, a first end 338 of each lock pin 336 is connected to a respective end segment 334 of the connecting link 332. As shown, the lock pins 336 may extend from the connecting link 332 in opposite directions.

The lock pins 336 are transformable between a first, locked position (FIG. 28A) in which the child safety seat 24 is not rotatable relative to the support base 22, and a second, unlocked position (FIG. 28B) in which the child safety seat 24 is freely rotatable relative to the support base 22. When each of the lock pins 336, and therefore the spin lock 330, is in a locked position, a second, opposite end 340 of the lock pin 336 is received within a corresponding lock section 342, such as a groove or opening for example formed in a portion of the support base 22. When the lock pins 336, and therefore the spin lock 330, is in the second, unlocked position, the second ends 340 of the lock pins 336 are separated from the lock sections 342, allowing the child safety seat 24 to be rotated relative to the second base member 78. In the illustrated, non-limiting embodiment, the plurality of lock sections 342 are formed in the second base member 78. However, embodiments where plurality of the lock sections 342 are formed in the first base member 74 or another suitable component are also contemplated herein. In an embodiment, a biasing member (not shown), such as a torsion spring for example, is operably coupled to the connecting link 332 to bias the connecting link 332, and therefore the lock pins 336, to the first locked position.

With continued reference to FIGS. 28A and 28B, and further reference to FIGS. 29-32B, at least one actuator 350 is operably coupled to at least one of lock pins 336. In the illustrated, non-limiting embodiment, a plurality of actuators are operably coupled to the spin lock 330. As shown, a first actuator 350a is operably coupled to a first lock pin 336 and a second actuator 350b is operably coupled to a second lock pin 336. Each actuator 350a, 350b may be independently or individually operable to transform the lock pins 336 from the locked position to the unlocked position. Alternatively, or in addition, the first and second actuator 350a, 350b may be operated simultaneously to transform the lock pins 336 from the locked position to the unlocked position.

In the illustrated, non-limiting embodiment, the plurality of actuators 350a, 350b are substantially identical and include a handle 352 arranged at an exterior surface of the child safety seat 24. The handle 352 may be directly or indirectly connected to a lock pin 336. As shown, each handle 352 is operably coupled to a corresponding lock pin by a wire, cable, or other suitable tension member 354. The handle 352 may be a portion of or integral with a driving member 356 pivotally mounted to the child safety seat 24. In such embodiments, the driving member 356 is positioned such that the handle 352 extends through an opening, such as in the seat back shell 29 for example and is exposed at an exterior of the child safety seat 24. However, embodiments where the handle 352 is separate from and is operably coupled to the driving member 356 are also contemplated herein. An engagement link 360 connected to the tension member 354 may be movably coupled to the driving member 356.

In the illustrated, non-limiting embodiment, the driving member 356 has an angled slot 362 formed therein and a pin 364 extending through an opening 366 formed in the engagement link 360, such as near an end thereof, is also received within the slot 362. The pin 364 is configured to translate within the slot 362 in response to rotation of the driving member 356. Because of the angled configuration of the slot 362, this translation of the pin 364 and the engagement link 360 relative to the driving member 356 applies a force on the tension member 354. As shown in FIG. 31, the driving member 356, engagement link 360, and a portion of the tension member 354 may be embedded within the seat back portion 26, such as between the seat back 27 and the seat back shell 29 for example.

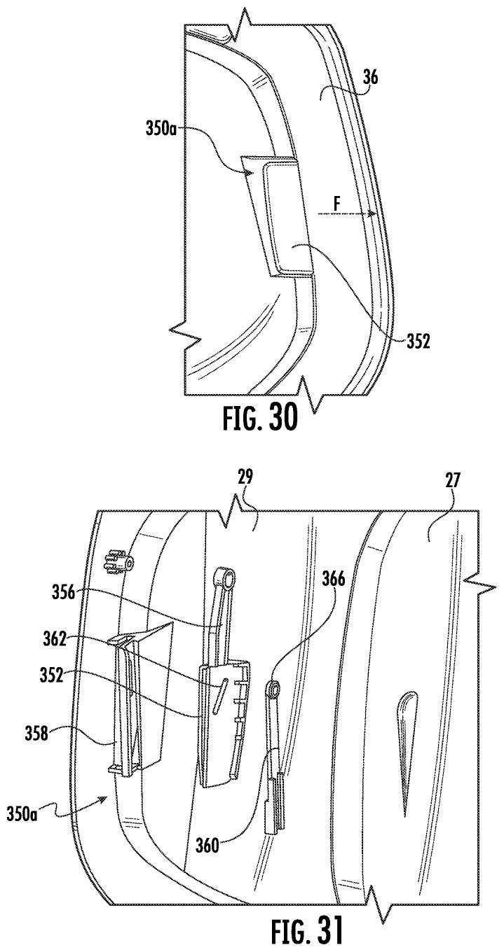

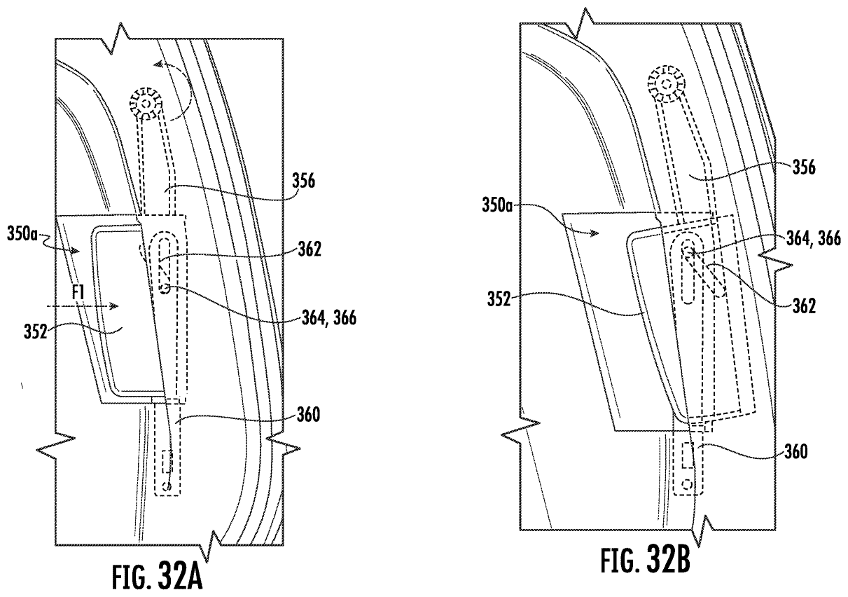

To operate the actuator 350a to unlock the spin lock 330, a user applies a force F1 (FIG. 32A) to the handle 352. In an embodiment, a user is configured to rotate the handle 352 forward. However, embodiments where the handle 352 is moved in another way, such as translated or pushed inwardly or pulled outwardly for example, are also within the scope of the disclosure. This movement of the handle causes the driving member 356 to rotate about its axis such that the pin 364 of the engagement link 360 moves upwardly within the slot 362 (see FIG. 32B). Accordingly. in response to the force applied to the handle 352, a force, in a direction opposing the bias of the biasing member, is applied to a corresponding lock pin 336. The movement or translation of the first lock pin 336 causes the connecting link 332 to rotate about its axis X against the bias of the biasing member. Because the second lock pin 336 is also coupled to the connecting link 332, rotation of the connecting link 332 via the first lock pin 336 causes a similar inward movement of the second lock pin 336. Via this inward movement, the second end 340 of both lock pins 336 is disengaged from the corresponding lock section 342 of the support base 22. With an actuator 350a, 350b operated and the lock pins 336 disengaged from the lock sections 342, a user may then rotate the child safety seat 24 relative to the support base 22 to a desired rotational configuration.

Once the child safety seat 24 has reached the desired rotational configuration, the user will release the actuator 350a, 350b. Upon release of the actuator 350a, 350b, the biasing force of the biasing member will cause the connecting link 332 to rotate and the lock pins 336 to move, for example translate, outwardly into engagement with the corresponding lock sections 342 associated with the rotational configuration of the child safety seat 24. This force applied to the tension members 354 via this outward movement causes the engagement link 360 to translate relative to the slot 362, and the driving member 356 to rotate about its axis back to an unactuated position. It should be appreciated that the spin lock 330 illustrated and described herein is intended as an example only and that any suitable configuration is within the scope of the disclosure.

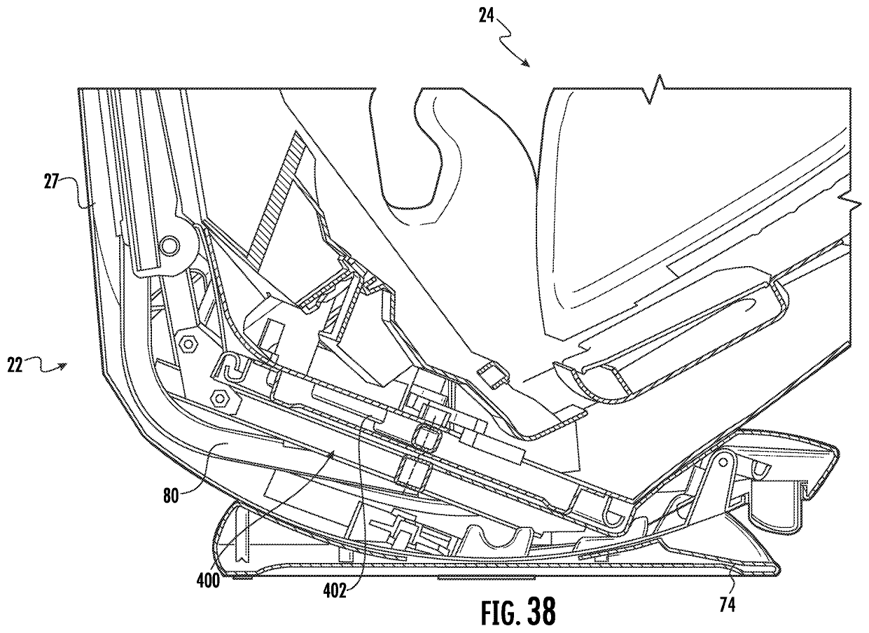

Another embodiment of a spin lock 400 is illustrated in FIGS. 38-40B. Similar to the previous embodiment, the spin lock 400 includes a center part 402 movably mounted to the child seat 24. In the illustrated, non-limiting embodiment, the center part 402 is translatable relative to the child seat 24. It should be appreciated that the child seat 24 is rotatable coupled to the support base 22 via a bolt or other suitable fastener (403) at a location other than the spin lock 400.

As shown, the center part 402 may include at least one engagement slot 404, such as a pair of engagement slots for example. At least one lock pin 406 may be pinned to the center part 402. In the illustrated, non-limiting embodiment, a pair of lock pins 406 are movably coupled to the pair of engagement slots 404, respectively. As shown, the lock pins 406 may extend outwardly from the center part 402 in opposite directions.

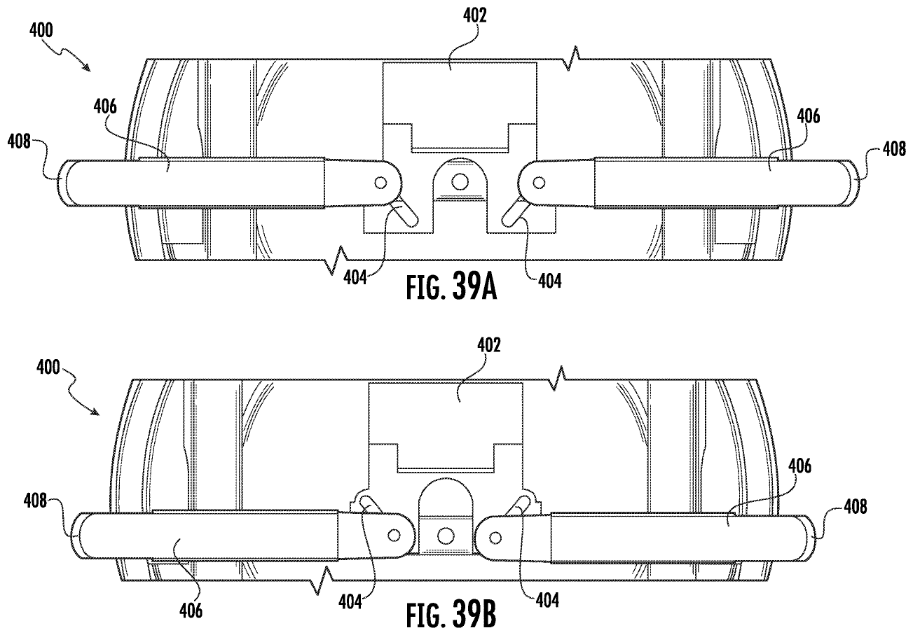

The lock pins 406 are transformable between a first, locked position (FIG. 39A) in which the child safety seat 24 is not rotatable relative to the support base 22, and a second, unlocked position (FIG. 39B) in which the child safety seat 24 is freely rotatable relative to the support base 22. When each of the lock pins 406, and therefore the spin lock 400, is in the locked position, a distal end 408 of the lock pins 406 is received within a corresponding lock section (not shown) formed in a portion of the support base 22. When the lock pins 406, and therefore the spin lock 400, is in the second, unlocked position, the distal ends 408 of the lock pins 406 are separated from the lock sections, allowing the child safety seat 24 to rotate relative to the support base 22.

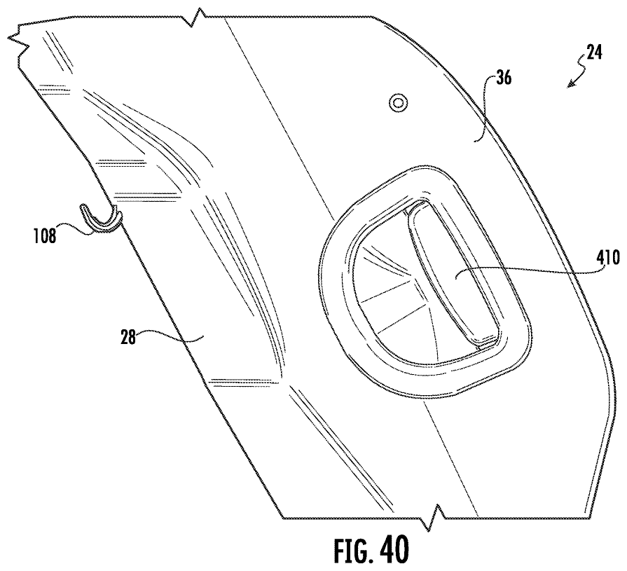

An actuator 410 (FIG. 40) operably coupled to the center part 402 is operable to transform the spin lock 400 between the locked and unlocked position. In the non-limiting embodiment, the actuator is illustrated as being located at an upright side member 36 of the seat back portion 28 of the child seat 24. However, embodiments where the actuator 410 of the spin lock is arranged at another position about the child seat 24 or even about the support base 22 are also contemplated herein. When operated, the actuator 410 applies a force to the center part 402. As shown, the engagement slots 404 formed in the center part 402 are arranged at a non-parallel angle relative to the direction of movement of the center part 402. Accordingly, the lock pins 406 are configured to translate inwardly as the lock pins 406 move within the engagement slots 404 in response to application of a force to the center part 402 by the actuator 410.

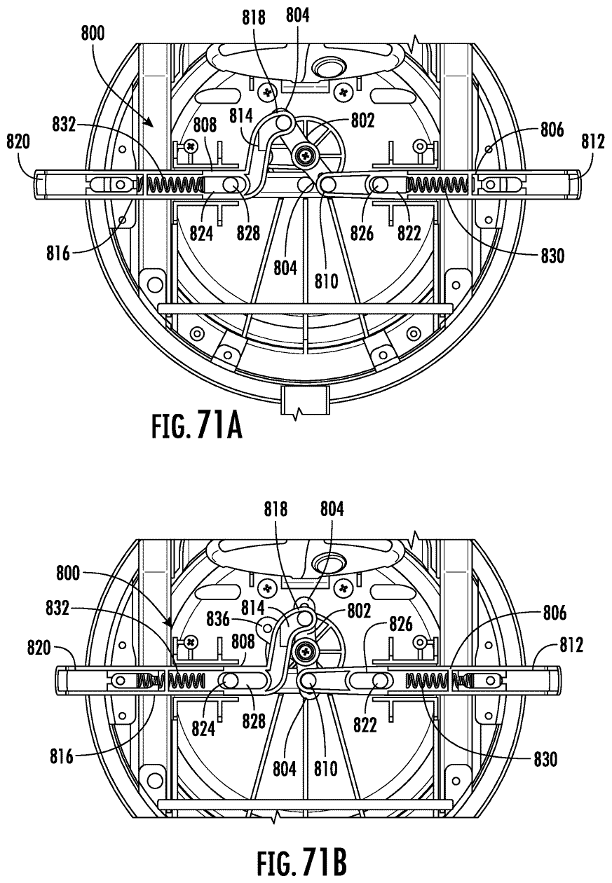

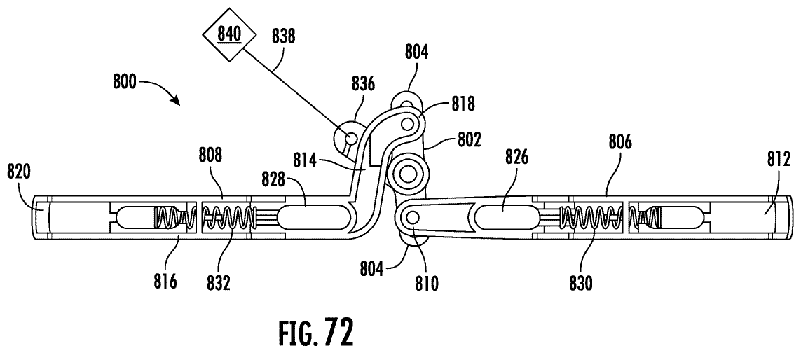

Yet another embodiment of a spin lock 800 is illustrated in FIGS. 71A-72. Similar to the previous embodiments, the spin lock 800 includes a centrally positioned connecting link 802 that is rotatable about an axis X. The connecting link 802 may be mounted to the support base 22 via a bolt or other suitable fastener. As shown, the connecting link 802 may have two end segments 804 extending outwardly therefrom, such as disposed on opposite sides of the connecting link 802 relative to axis X of rotation. A plurality of lock pins 806, 808 may be connected to the connecting link 802. Unlike the previously described embodiments where the two lock pins may be substantially identical, in the illustrated, non-limiting embodiment, the first lock pin 806 has a first configuration, and the second lock 808 has a second configuration different from the first configuration. As shown, the first lock pin 806 may be generally rectangular in shape such that a first end 810 and a second end 812 of the first lock pin 808 are coaxial. The first end 810 of the first lock pin 806 may be connected to an end segment 804 of the connecting link 802 and the second end 812 of the first lock pin 808 extends outwardly towards an outer periphery of the support base 22. A second lock pin 808 may include a first section 814 have a generally curved or arcuate contour and a second section 816 having a rectangular configuration coupled to or integrally formed with the first section 816. A first end 818 of the second lock pin 808, such as formed at the first actuate section 814 for example, may be connected to an end segment 804 of the connecting link 802 and a second end 820 of the second lock pin 808 arranged at the second section 816 may extend radially outward from the connecting link 802. As shown, the first lock pin 806 and the second section 816 of the second lock pin 808 may be coaxial. Further, this axis of the first lock pin 806 and the second section 816 of the second lock pin 808 may be spaced or offset from, and therefore does not intersect, the axis of rotation X of the connecting link 802.

The first lock pin 806 and the second lock pin 808 are movable between a first locked position (FIG. 71A) in which the child safety seat 24 is not rotatable relative to the support base 22, and a second unlocked position (FIG. 71B) in which the child safety seat 24 is freely rotatable relative to the support base 22. When in a locked position, the second ends 812, 820 of the lock pins 806, 808 are received within a corresponding lock section (not shown) formed in a portion of the support base 22. When the lock pins 806, 808, and therefore the spin lock 800, is in the second, unlocked position, the second ends 812, 820 of the lock pins 806, 808 are separated from the lock sections allowing the child safety seat 24 to be rotated relative to the support base 22.

In the illustrated, non-limiting embodiment, the first lock pin 806 and a portion of the second lock pin 808, such as the second section 816 for example, have a slot 822, 824 formed therein, and pin or fastener 826, 828 is arranged within a respective slot 822, 824. This engagement between a pin 826, 828 and corresponding slot 822, 824 defines the path of movement of each of the first and second lock pins 806, 808. As the spin lock 800 transforms between the locked position and the unlocked position, each slot 822, 824 translates relative a respective pin 826, 828. The pin 826, 828 may be arranged adjacent to a first end of the slot 822, 824, such as the end of the slot 822, 824 closest to the connecting link 802 when the spin lock 800 is in the locked configuration, and the pin 826, 828 may be arranged adjacent to a second, opposite end of the slot 822, 824 when the spin lock 800 is in the unlocked configuration.

At least one biasing mechanism is operably coupled to the spin lock 800 to bias the first and second lock pins 806, 808 radially outwardly toward the locked position. In an embodiment, the biasing mechanism is coupled to the connecting link 802. However, in other embodiments such as shown in the FIGS., a respective biasing member, 830, 832 such as a coil spring for example, is operably coupled to each of the first and second lock pins 806, 808 and is operable to bias the first and second lock pins 806, 808 to the first, locked position.

An actuator illustrated schematically at 840 (FIG. 72) is operably coupled to the spin lock 800. In the illustrated, non-limiting embodiment, the connecting link 802 includes a radially extending actuation tab 836 and the actuator 840 is coupled to the actuation tab 836 via a linkage or tension member 838. Application of a force to the actuator 840 is operable to rotate the connecting link 802 about its axis X. This rotation will apply a force to the first and second lock pins 806, 808, causing the lock pins 806, 808 to translate from the locked position to the unlocked position. While the lock pins 806, 808 are held in the unlocked position via application of a force to the actuator 840, the second base member 78 is translatable relative to the first base member 74. Further, the actuator 840 may be biased to a normal position in response removal of a force applied to the actuator 840. The actuator 840 may be located at any suitable position about the child safety seat 24, such as at an exterior surface of an upright side member for example. Alternatively, the actuator 840 may be positioned at the support base, such as at the first base member 76 or the second base member 78 for exmaple.

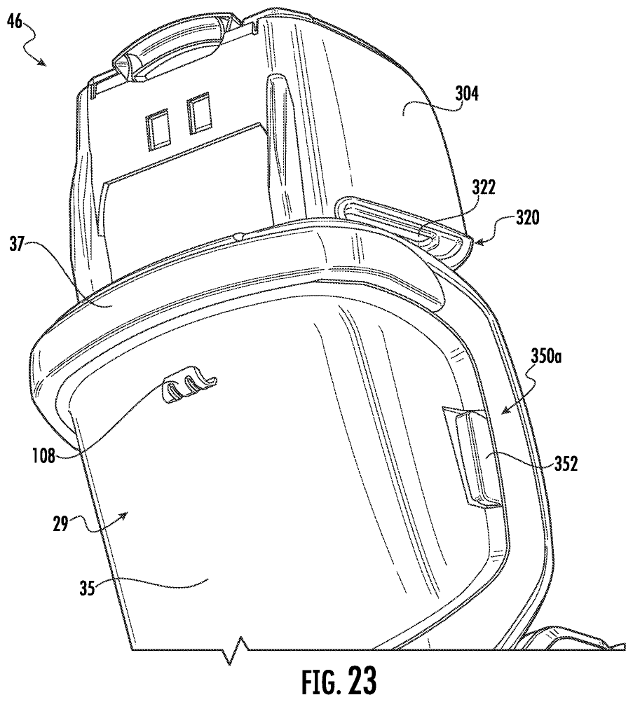

At least one base anchor member 104 may be fixedly connected to a portion of the second base member 78. For example, the base anchor member 104 may be part of the frame 80 and extend through an opening formed in the structural shell 82 (see FIG. 2). Although the illustrated, non-limiting embodiment includes a base anchor member 104 arranged near a distal end 106 of the second base member 78 at the base back portion 72 of the support base 22, it should be appreciated that the base anchor member 104 may be arranged at any suitable location. The base anchor member 104 is connectable to a corresponding seat anchor member 108. In an embodiment, the seat anchor member 108 is located at the third base member 86. For example, the seat anchor member 108 may be arranged at the base member back portion 90 such that the base anchor member 104 is connectable thereto when the child safety seat 24 is connected to the third base member 86 is in a forward-facing configuration. In the illustrated, non-limiting embodiment, the seat anchor member 108 includes a contoured flange or groove complementary to the base anchor member 104. In other embodiments, the seat anchor member 108 may be arranged at the child safety seat 24. For example, in the non-limiting embodiment of FIGS. 21B and 23, a seat anchor member 108 protrudes from the seat back portion 26, such as from the exterior surface 35 thereof.

As will be described in more detail below, the base anchor member 104 may also be connectable to the seat anchor member 108 regardless of the angle of incline of the child safety seat 24 relative to the support base 22. This connection between the base anchor member 104 and the seat anchor member 108 stabilizes the seat back portion 26 of the child safety seat 24. In such embodiments, the base anchor member 104 may not be connectable to the seat anchor member 108 when the child safety seat 24 is in a rearward-facing configuration. However, it should be understood that the base anchor member 104 may be suitable for use with a seat anchor member 108 arranged at any location about the third base member 86 and/or the child safety seat 24.

Alternatively, or in addition, the child safety seat 24, when coupled to the support base 22, may be movable relative to at least a portion of the support base 22 to adjust an incline of the child safety seat 24. In an embodiment, the second base member 78 is movable, for example translatable, relative to the first base member 74 along an incline path to control an incline or recline of the child safety seat 24. Because the third base member 86 is coupled to the second base member 78, the third base member 86 and the child safety seat 24 connectable thereto, are movable in unison with the second base member 78 between a first position, such as associated with upright position of the child safety seat 24, and a second position, such as associated with a reclined position of the child safety seat 24. However, it should be appreciated that the first recline position and the second recline position may both be positions arranged at an incline, the positions having varying degrees of incline. Further, embodiments where the child safety seat 24 may be arranged in any of a plurality of recline positions between the upright position and the reclined position are also contemplated herein.

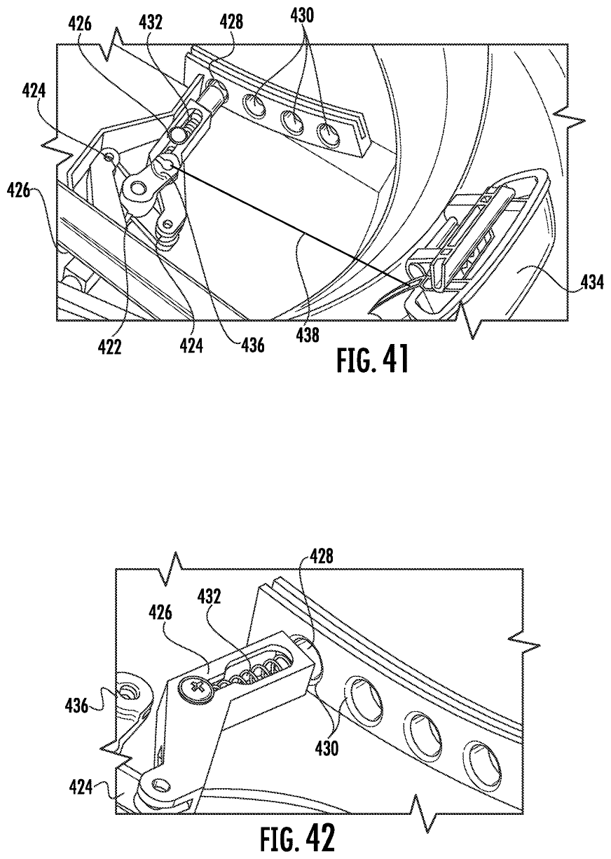

Further, the support base 22 may include a recline lock mechanism operable to selectively lock the second base member 78, and therefore the child safety seat 24 coupled thereto via the third base member 86, at one of a plurality of positions along the incline path. An example of a recline lock mechanism 420 is illustrated in FIGS. 41-44B. As shown, the recline lock mechanism 420 includes a centrally positioned pivot link 422 that is rotatable about an axis. As shown, the pivot link 422 may have two end segments 424 extending outwardly therefrom, such as disposed on opposite sides of the pivot link 422 relative to its axis of rotation. At least one recline pin 426, such as two recline pins for example, are connected to the pivot link 422. As shown, the recline pins 426 may extend from the pivot link 422 in opposite directions.

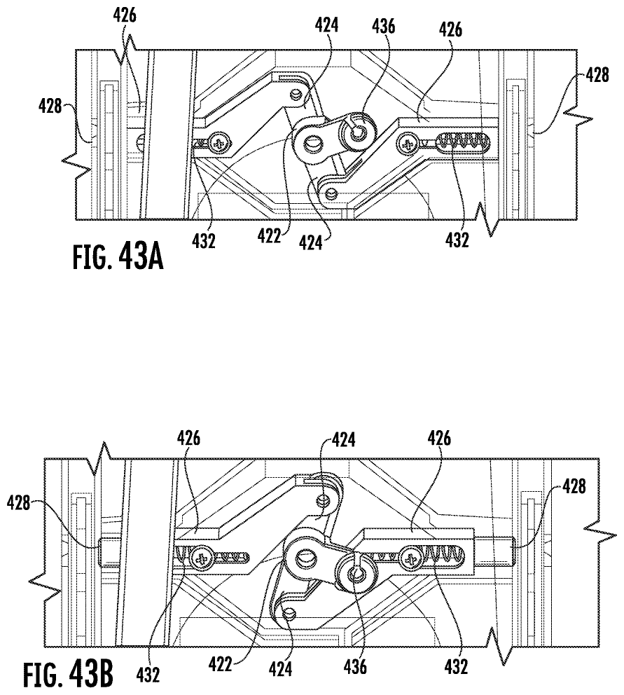

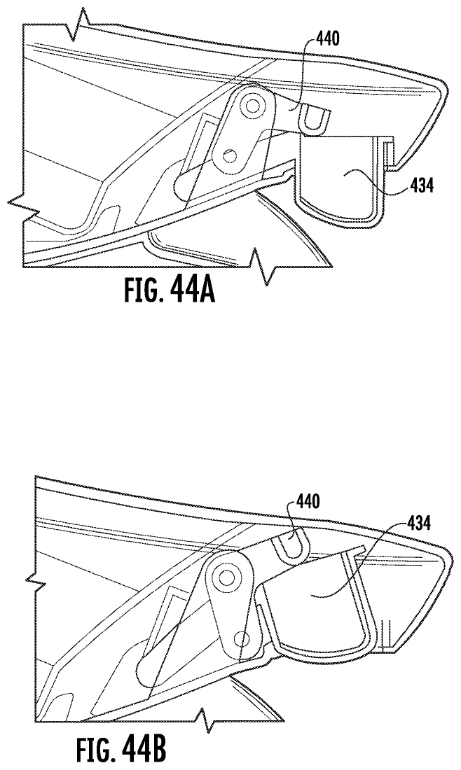

The plurality of recline pins are transformable in unison between a first, locked position (FIGS. 42, 43A, 44A) in which the second base member 78 is not movable relative to the first base member 74, and a second, unlocked position (FIGS. 43B and 44B) in which the second base member 78, and therefore the child seat 24 rotatably coupled to the second base member 78, is freely movable relative to the first base member 74 to adjust an incline of the second base member 78 and the child seat 24. When each of the recline pins 426 is in a locked position, a second end 428 of the recline pins 426 is received with a corresponding lock opening 430, formed in a portion of the first base member 74, such as a sidewall thereof for example. When the recline pins 426 are in the second, unlocked position, the second ends 428 of the recline pins 426 are separated or disengaged from the lock openings 430, allowing the second base member 78 and the child seat 24 to be inclined or reclined.

In an embodiment, a respective biasing member 432, such as a coil spring for example, is operably coupled to each of the recline pins 426 and is operable to bias the recline pins 426 to the first, locked position. An actuator 434 is operably coupled to the recline lock mechanism 420. In the illustrated, non-limiting embodiment, the pivot link 422 includes a radially extending actuation tab 436 and the actuator 434 is coupled to the actuation tab 436 via a linkage or tension member 438. Application of a force to the actuator 434 is operable to rotate the pivot link 422 about its axis. This rotation will apply a force to the recline pins 426, causing the recline pins 426 to translate from the locked position to the unlocked position. While the recline pins 426 are held in the unlocked position via application of a force to the actuator 434, the second base member 78 is translatable relative to the first base member 74. The actuator 434 may be biased to a normal position in response removal of a force applied to the actuator 434. A biasing mechanism (not shown) may be directly coupled to the actuator 434, or alternatively, a biasing mechanism may be associated with an intermediate component, as shown in FIGS. 44A and 44B, operable to engage and transmit the biasing force to the actuator 434.

As shown in FIG. 42, the first base member 74 includes a plurality of lock openings 430, each associated with a different incline or recline of the child seat 24. The second base member 78 is therefore movable to a position in which the ends 428 of the recline pins 426 are aligned with and configured to engage respective lock openings of the plurality of lock openings 430. It should be appreciated that the recline lock mechanism 420 illustrated and described herein is intended as an example only and that any mechanism suitable to selectively lock and unlock the child seat 24 and/or second base member 78 with respect to movement relative to the first base member 74 to adjust an incline of the child seat 24 is within the scope of the disclosure. Further, the child safety seat 24 may be rotatable relative to the support base between a forward-facing configuration and a rearward-facing configuration when the child seat is locked in any of the plurality of the recline positions.

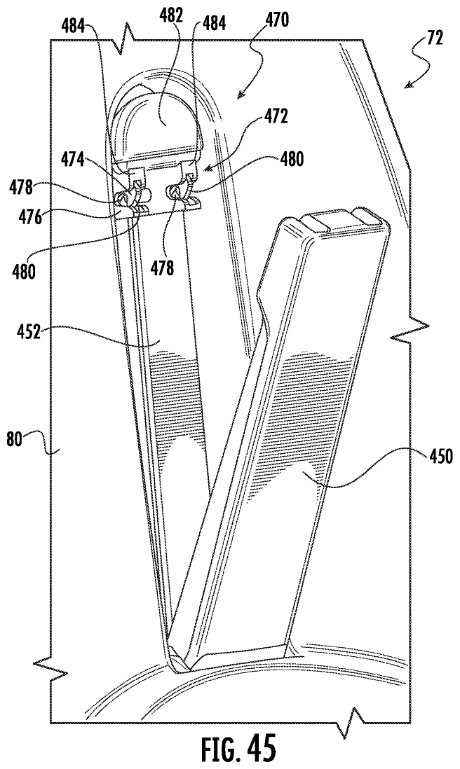

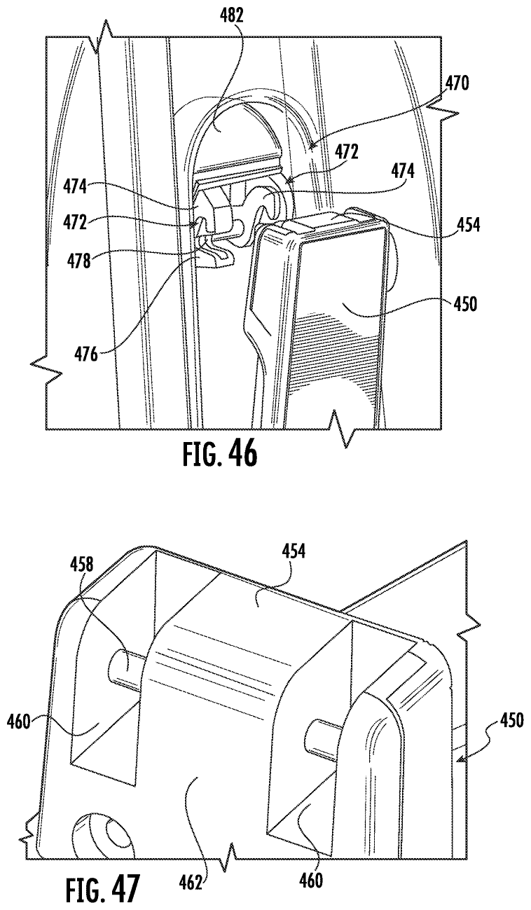

With reference now to FIGS. 45-47, in an embodiment, the support base 22 includes a belt tensioner 450. In the illustrated, non-limiting embodiment, an opening 452 is formed in the base back portion of the support base 22, such as in the second base member 78 for example, and the belt tensioner 450 is receivable within the opening 452. A contour of the belt tensioner 450 may be complementary to that of the opening 452 such that the substantial entirety of the belt tensioner 450 is receivable within the opening 452. A vehicle belt associated with the vehicle seat 10 is positionable along a belt receiving path defined between a surface of the base back portion 72 of the support base 22 and the belt tensioner 450. In an embodiment, the belt tensioner 450 is selectively movable relative to the support base 22 to adjust the tension applied to the vehicle belt 12 along the vehicle belt receiving path. For example, the belt tensioner 450 may be configured to pivot about at least one axis between an open position (FIGS. 45 and 46) and a closed position (FIG. 38) to selectively tension the portion of the vehicle belt 12 sandwiched between the belt tensioner 450 and the opening 452 to couple the support base 22 to the vehicle belt 12, thereby restricting movement of the support base 22 relative to the vehicle seat 10.

A belt tensioner locking mechanism 470 may be used to retain the belt tensioner 450 in the closed position. As shown, a portion of the belt tensioner 450, such as near a top end 456 thereof includes a rigid shaft or pin 458. One or more slots 460 may be formed at the surface 462 of the belt tensioner 450 facing the opening 452 and may extend to the shaft 458 to define a passageway for accessing the shaft 458. At least one clasp 472 is arranged within the opening 452 at a position aligned with the slots 460 formed in the surface 462 and is couplable to the shaft 458. In an embodiment, each clasp 472 includes a movable member 474 and a stationary member 476. When the clasp 472 is open (FIG. 46), the movable member 474 is arranged at a non-parallel angle relative to the stationary member 476. Accordingly, the ends of the movable member 474 and the stationary member 476 are separated from one another and define an opening for receiving the shaft 458. When the clasp 472 is closed (FIG. 45), the movable member 474 is rotated toward the stationary member 476. In the closed configuration, the movable member 474 may be oriented substantially parallel to the stationary member 476 and the distal ends of the movable member 474 and the stationary member 476 may overlap one another. Accordingly, when closed, the opening 478 defined between the movable member 474 and the stationary member 476 is substantially enclosed, thereby locking the shaft 458 in position relative to the clasp.

A biasing mechanism (not shown) may be associated with the movable member 474 of the clasp 472 and operable to bias the movable member 474 towards the stationary member 476 toward a closed position. As the belt tensioner 450 is pivoted towards the opening 452 and the clasp 472, the shaft 458 may engage a forward-facing surface 480 of the movable member 474. In the illustrated, non-limiting embodiment, the forward-facing surface 480 of the movable member 474 is contoured, for example sloped, such that the engagement between the shaft 458 and the forward-facing surface 480 pushes the movable member 474 away from the stationary member 476, opposite the bias of the biasing mechanism. Once the shaft 458 is beyond the forward-facing surface 480, the bias will cause the movable member 474 to rotate toward the stationary member 476 such that the shaft 458 is enclosed within the opening 478.

An actuator 482 is operably coupled to the at least one clasp 472 to selectively open the at least one clasp 472 to release the belt tensioner 450. Although the actuator 482 is illustrated as being located directly adjacent to the belt tensioner locking mechanism 470, it should be appreciated that embodiments where the actuator 482 is located remotely therefrom are also within the scope of the disclosure. The actuator 482 is operably coupled to the movable member 474 of the at least one clasp 472 by a linkage 484 (see FIG. 45) or other suitable connection. Accordingly, when a force is applied to the actuator 482, such as when the actuator 482 is depressed for example, the force is transmitted to the movable member 474 via the linkage 484. The force opposes the bias of the biasing mechanism thereby separating the movable member 474 from the stationary member 476. In the separated or open position, the belt tensioner 450 may be moved away from the belt opening 452.

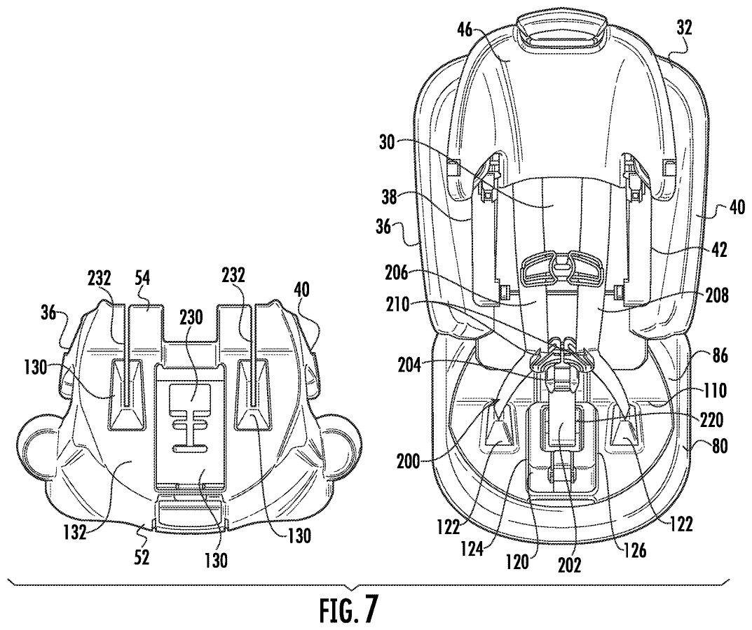

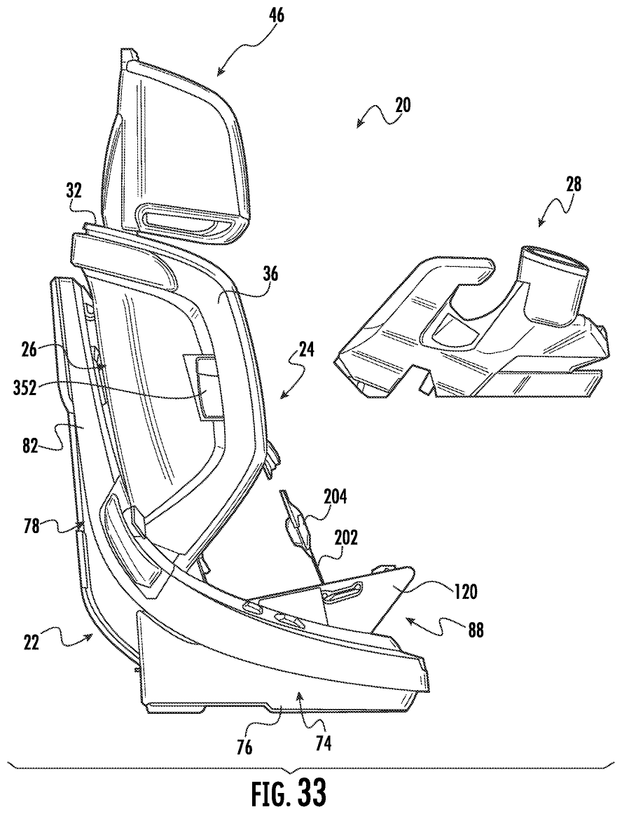

As suggested above, at least a portion of the child safety seat 24 is removably connectable to the third base member 86. In an embodiment, the seat pan portion 28 is detachable from the third base member 86, such as from the base member seat portion 88 thereof for example. With reference to FIGS. 5-7, and 33, the base member seat portion 88 may include at least one upwardly protruding attachment member, such as extending from a surface 110 along a direction between a rear end and a front end thereof. The illustrated, non-limiting embodiment of FIGS. 5-7 and 33 includes a first attachment member 120 arranged generally centrally between the lateral sides of the base member seat portion 88. Further, two substantially identical second attachment members 122 may be laterally spaced from a first side 124 and a second side 126, respectively of the first attachment member 120. However, it should be appreciated that embodiments including a single attachment member and/or at least one attachment member arranged at another location about the base member seat portion 88 are also contemplated herein. Each attachment member 120, 122 may be shaped as a tube, bar, block, or any other suitable shape. The one or more attachment members 120, 122 may be formed from a suitably rigid material and can be fixedly attached to the base member seat portion 88, or alternatively, may be integrally formed with the body of the third base member 86.

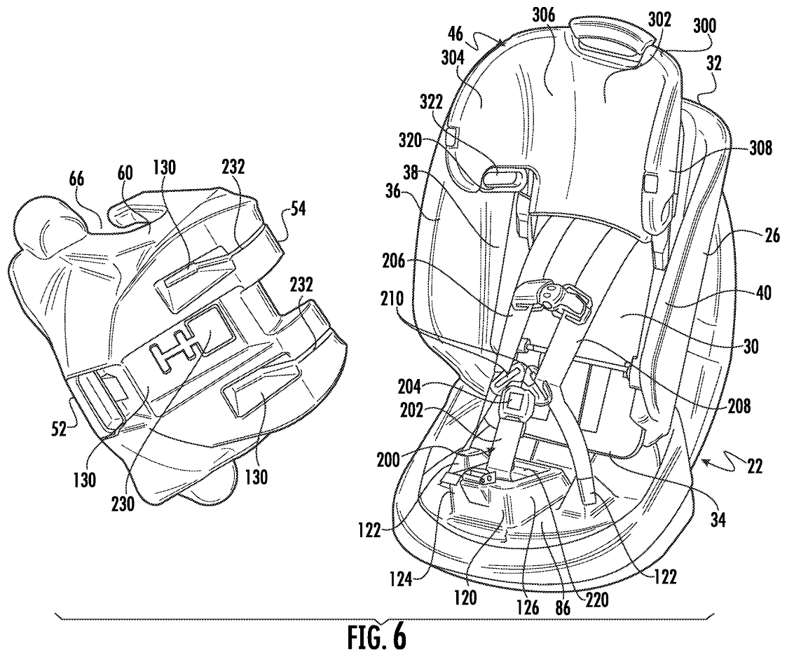

As illustrated in FIGS. 6, 7, 36A and 36B, at least one positioning feature 130, such as a groove for example, is formed in one or more surfaces of the seat pan portion 28 of the child safety seat 24, such as the bottom surface 132 of the seat pan portion 28 that is configured to abut the upper surface 110 of the seat pan portion 28. Each seat positioning feature 130 may be complementary in size and/or shape to a corresponding one of the attachment members 120, 122 such that the attachment members are receivable therein. This alignment and/or engagement between the attachment members 120, 122 and the seat positioning features 130 properly locates or positions the seat pan portion 28 adjacent to the base member seat portion 88.

In an embodiment, the seat pan portion 28 of the child safety seat 24 is loosely positioned about the support base, such as the base member seat portion 88. As used herein, the term “loosely positioned” describes embodiments where the seat pan portion is simply arranged in contact with the support base, but the seat pan portion is not otherwise connected thereto. As a result, in this loosely positioned configuration, a user can easily separate the seat pan portion 28 from the support base 22 simply by lifting and/or rotating the seat pan portion 28 away from the third base member 86. The weight of an occupant may be sufficient to restrict undesired separation of the seat pan portion 28 from the third base member 86. In other embodiments, the seat pan portion 28 may be coupled or affixed to the third base member 86 via a booster locking mechanism. In such embodiments, the booster locking mechanism prevents unintended separation of the seat pan portion 28 from the third base member 86. Accordingly, the booster locking mechanism must be deactivated, such as by disconnecting corresponding parts of the booster locking mechanism for example, prior to separation of the seat pan portion 28 from the third base member 86.

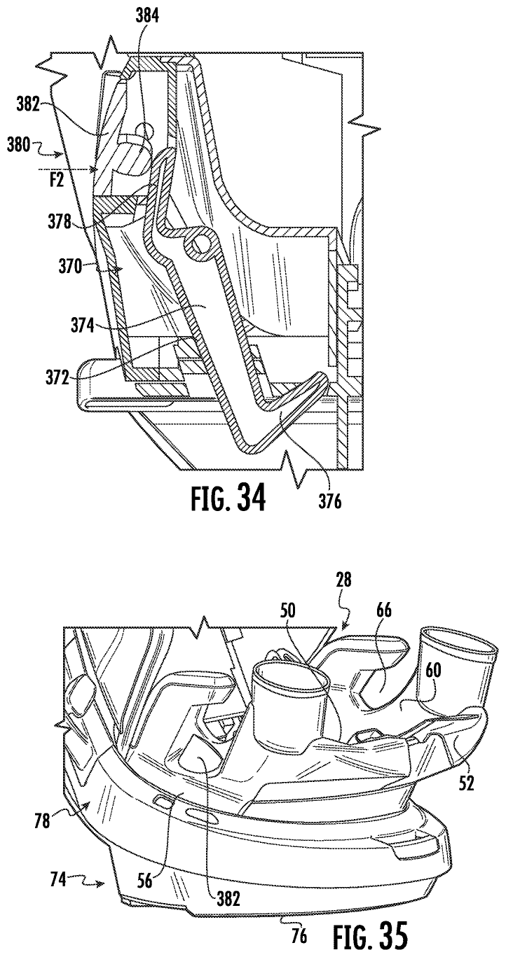

An example of a booster locking mechanism 370 is illustrated in FIG. 34. As shown, the booster locking mechanism 370 includes at least one locking member 372 movably mounted to the seat pan portion 28. In the illustrated, non-limiting embodiment, the locking member 372 is pivotally mounted to an underside of the seat pan portion 28, such as near a first or second seat side member 56, 60. The locking member 372 includes an elongated body 374 having an engagement feature 376 arranged at a first end thereof and an actuation face 378, such as arranged near a second end thereof. The engagement feature 376 may be oriented at a non-parallel angle to the body. A biasing member (not shown), such as a torsion spring for example, is operably coupled to the locking member 372 and is operable to bias the locking member 372 toward a first, locked position (shown). In the locked position, the engagement feature 376 extending from the body 374 is arranged in contact with or abuts against a surface of the third base member 86.

An actuator 380 is operably coupled to the locking member 372. With continued reference to FIG. 34 and further reference to FIG. 35, the actuator 380 includes a handle 382 arranged at an exterior surface of the child safety seat 24. In the illustrated, non-limiting embodiment, the handle 382 is arranged at an exterior surface of the seat pan portion 28, such as at one of the first or second seat side members 56, 60 for example. The handle 382 may be directly or indirectly coupled to a locking member 372. As shown, an actuation member 384 may extend from a surface of the handle 382 toward the interior of the seat pan portion 28. The actuation member 384 may be positioned in alignment with the actuation face 378 of the locking member 372.

To operate the actuator 380 to unlock the seat pan portion 28 from the third base member 86, a user applies a force F2 to the handle 382. In an embodiment, a user is configured to push or translate the handle 382 inwardly. However, embodiments where the handle 352 is moved in another way, such as pulled outwardly or rotated for example, are also within the scope of the disclosure. This movement of the handle 382 moves the actuation member 384 into engagement with and transmits the force to the actuation face 378. The force applied to the actuation face 378 opposes the bias of the biasing member causing the locking member 372 to rotate about its axis to a second unlocked position. In this second unlocked position, the engagement feature 376 is separated from or disengaged with the third base member 86. Although only a single locking member 372 is illustrated in FIG. 34, it should be appreciated that embodiments including a plurality of locking members are within the scope of the disclosure. For example, a locking member 372 may be arranged adjacent to each of the first or second seat side member 56, 60. In such embodiments, a single actuator may be operable coupled to the plurality of locking members 372, or alternatively, a respective actuator 380 may be associated with a corresponding locking member 372.

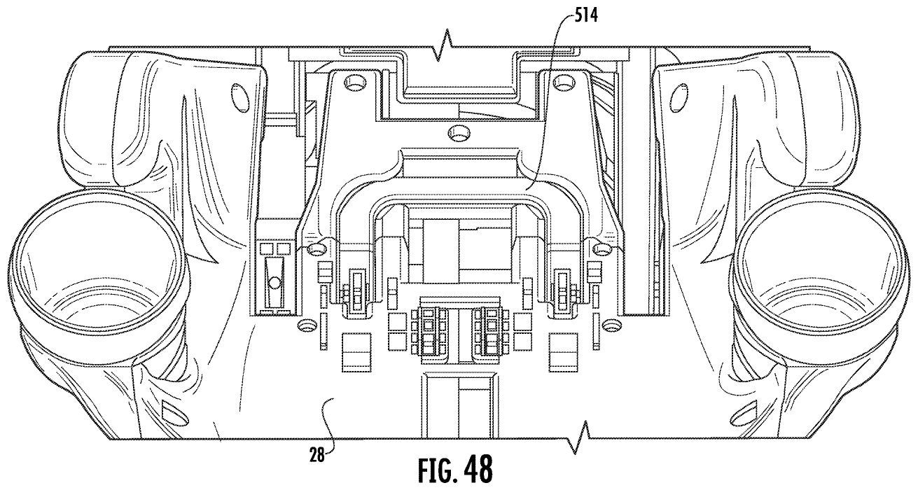

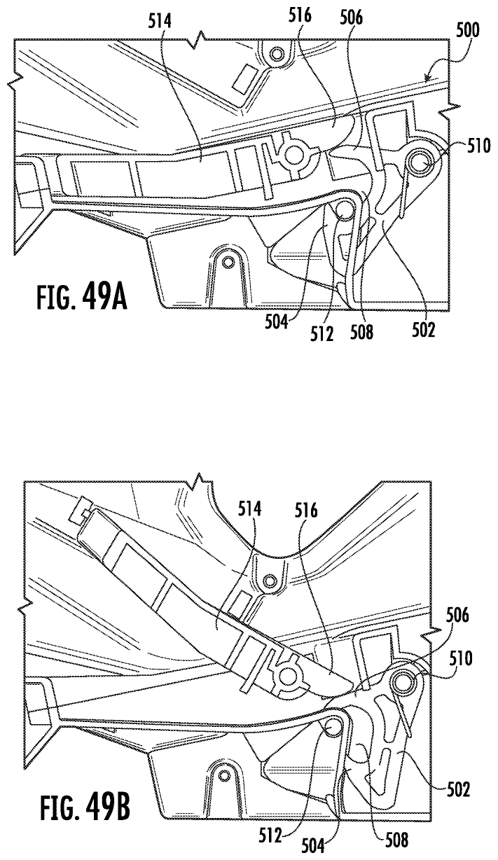

With reference to FIGS. 48-49B, another embodiment of a booster locking mechanism 500 is illustrated. The booster locking mechanism 500 includes at least one locking member 502 pivotally mounted to the seat pan portion 28, such as an underside of the seat pan portion 28 for example. In an embodiment, the locking member 502 is a latch plate. Similar to the previous embodiment shown in FIGS. 34 and 35, the latch plate 502 includes an engagement member 504 arranged at a first end thereof and a release member 506, such as arranged near a second end thereof. A recess 508 may be defined between the engagement member 504 and the release member 506. A biasing mechanism 510, such as a torsion spring for example, may be operably coupled to the latch plate 502. In an embodiment, the biasing mechanism 510 is operable to bias the latch plate 502 toward a first, locked position (FIG. 49A). In the first locked position, a pin or shaft 512 arranged at the third base member 86 is received within the recess 508 and/or is engaged by the engagement member 504 of the latch plate 502.

The seat pan portion 28 additionally includes an actuator 514 operably coupled to the booster locking mechanism 500. In the illustrated, non-limiting embodiment, the actuator 514 is a release handle arranged at an exterior surface of the seat pan portion 28, such as an upper surface thereof. The actuator 514 may be pivotably mounted to the seat pan portion 28. The actuator 514 may be substantially flush with the upper surface of the seat pan portion 28 when unactuated. In an embodiment, the axis of rotation of the actuator is parallel to the axis of rotation of the latch plate 502. A portion of the actuator 514, such as a distal end 516 thereof for example, is configured to contact the release member 506 of the latch plate 502. In response to lifting the actuator 514, the actuator 514 pivots about its axis such that the distal end 516 engages and applies a force to the release member 506 of the latch plate 502. This engagement causes the latch plate 502 to rotate in a direction opposing the biasing force of the biasing mechanism 510. This movement of the latch plate 502 disengages the pin 512 and the engagement member 504 of the latch plate 502. Once disengaged, the seat pan portion 28 may be separated from the remainder of the child seat 24.

In some embodiments, the seat back portion 26 of the child safety seat 24 is not separable from the support base 22. However, in other embodiments, both the seat pan portion 28 and the seat back portion 26 are detachable from the third base member 86. More specifically, the seat pan portion 28 may be removably connectable to the base member seat portion 88 and the seat back portion 26 may be removably connectable to the base member back portion 90 of the third base member 86. Further, the seat pan portion 28 may be separable from the seat back portion 26 such that the seat pan portion 28 and the seat back portion 26 may be independently separable from the third base member 86.

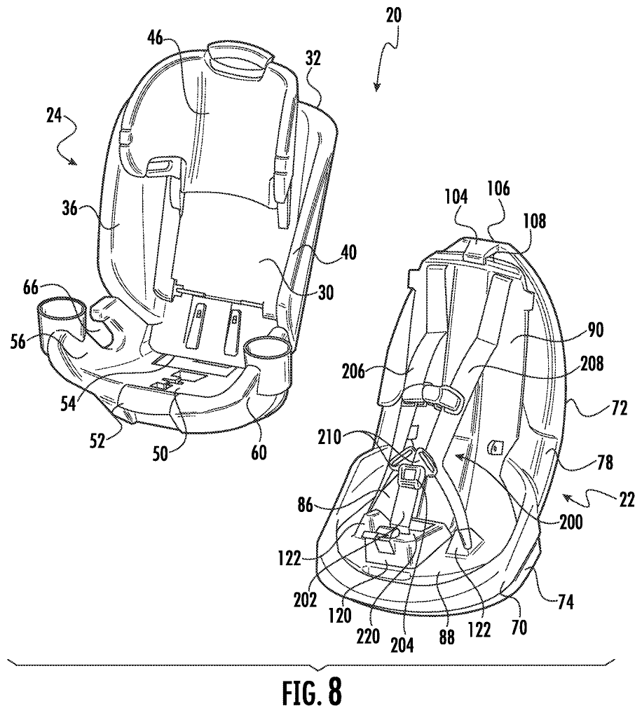

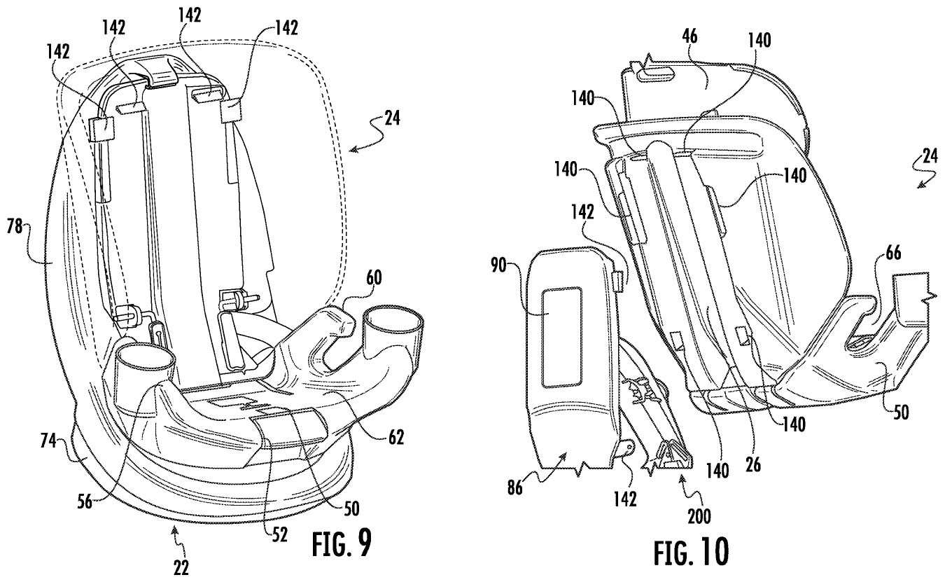

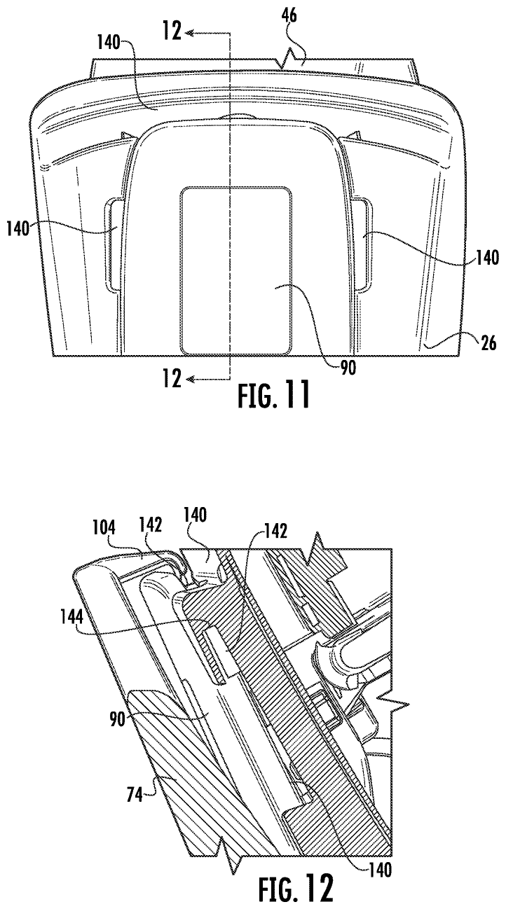

In the illustrated, non-limiting embodiment shown in FIGS. 8-12, the seat back portion 26 includes at least one, and in some embodiments, a plurality of seat interlock features 140, such as grooves, recesses, or openings for example. The base member back portion 90 may similarly include at least one base interlock feature 142, such as a flange, rib, or other protrusion for example, configured to engage, be received within, or seat against a respective seat interlock feature 140. This engagement between the at least one seat interlock feature 140 and the at least one base interlock feature 142 properly positions the base member back portion 90 of the third base member 86 relative to the adjacent seat back portion 26.

In the non-limiting embodiment shown in FIG. 12, the base interlock feature 142 is smaller than a corresponding seat interlock feature 140. Accordingly, the base interlock feature 142 is receivable within a first portion of the seat interlock feature 140 and then may be movable, for example slidable, to a second portion of the seat interlock feature 140. Within the second portion of the seat interlock feature 140, the base interlock feature 142 may abut a plurality of surfaces of the seat back portion 26, such as an upper end 144 of the seat interlock feature 140 for example, thereby restricting unintended separation of the base interlock feature 142 from the seat interlock feature 140.

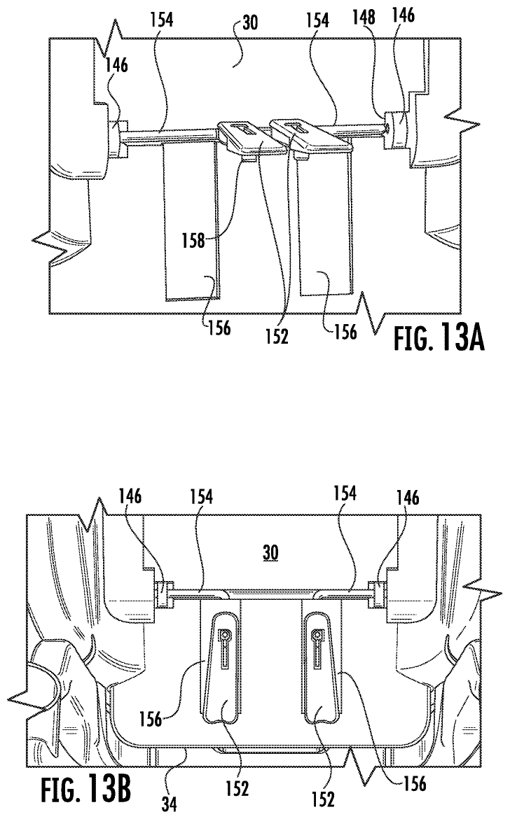

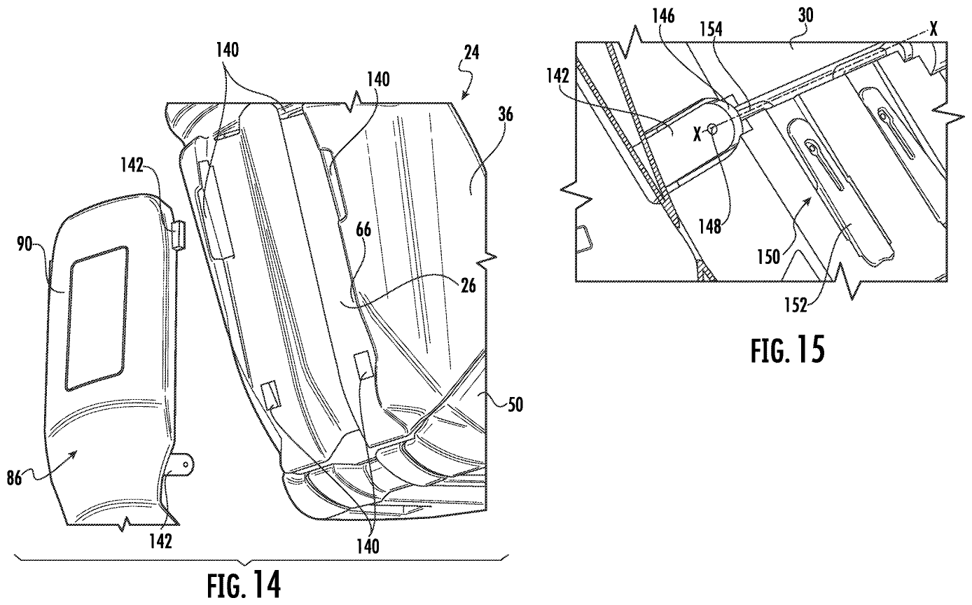

In an embodiment, the base member back portion 90 includes at least one base interlock feature 142 protruding from near a bottom thereof, and the seat back portion 26 includes at least one seat interlock feature 140, such as an opening for example, within which the base interlock feature is receivable. As shown in FIGS. 13A-15, the at least one base interlock feature 142 may extend through the seat back portion 26, such that at least a distal end 146 of the base interlock feature 142 is arranged generally adjacent to the upright support surface 30. The seat back portion 26 may include an engagement feature 150 movable relative to the upright support surface 30 to selectively engage an adjacent base interlock feature 142. In the illustrated, non-limiting embodiment, the engagement feature 150 is a pin lock including a handle 152 and a pin 154 extending from the handle 152. The base interlock feature 142 includes an opening or through hole 148 and a free end of the pin 154 is receivable within opening 148 to couple the base interlock feature 142, and therefore the third base member 86, to the seat back portion 26.

The pin lock 150 may be translatable into engagement with the base interlock feature 142. For example, the pin lock 150 may be configured to slide along an axis X between an unlocked position (FIG. 13A) and a locked position (FIG. 13B). In the unlocked position, the distal or free end of the pin 154 is spaced inwardly from the base interlock feature 142 and in the locked position, the pin 154 is received within the opening 148 of the base interlock feature 142. In some embodiments, the pin lock 150 is also rotatable about the axis to retain the pin lock 150 in the locked position. As shown, the pin lock 150 may be rotatable out of the plane of the upright support surface 30 between a first position where the handle 152 extends at a non-parallel angle to the adjacent upright support surface 30 and a second position in which the handle 152 is substantially parallel angle to the adjacent upright support surface 30. The upright support surface 30 of the seat back portion 26 may have one or more grooves or recesses formed therein 156 such that when the pin 154 is the locked position and the handle 152 is in the second position, at least a portion of the handle 152 is arranged within the recess 156. Alternatively, or in addition, the pin 154 of the pin lock 150 may be arranged within a recess 156, such as the same recess or a different recess for example. Via such a configuration, the handle 152 and/or the pin 154 may be positioned at a location that avoids or minimizes contact with an occupant's back. Further, the handle 152 may include a tab, flange, or other feature 158 configured to engage or abut a corresponding surface of the recess 156 when the handle 152 is arranged in the second position. This engagement may prevent unintended rotation of the handle 152 from the second position.

Although translation and rotation of the pin lock 150 are described as occurring separately or sequentially, in other embodiments, rotation of the pin lock 150 about the axis X from the first position to the second position causes about the pin lock 150 to simultaneously translate along the axis X between the unlocked position and the locked position. For example, a user may apply a downward force to the handle 152 causing the handle 152 to rotate about the axis X and as the handle 152 rotates downwardly, the pin lock 150 slides laterally into engagement with the through hole 148 of the base interlock feature 142. It should be appreciated that the engagement feature 150 and the interface with a corresponding the base interlock feature 142 as illustrated and described herein is intended are intended as an example only and any suitable mechanism for removably coupling the third base member 86 to the seat back portion is contemplated herein.

A portion of the child safety seat system 20, such as the support base 22 for example, may include a harness 200 operable to secure a child in the child seat within the child safety seat system 20 when the child seat is in at least one of a plurality of configurations. In the illustrated, non-limiting embodiment, the harness 200 is attached to and is positioned adjacent to the third base member 86. The harness, best shown in FIGS. 5-8, may include multiple harness straps, including but not limited to shoulder straps, waist straps, and a crotch strap.

In an embodiment, the harness 200 includes a crotch strap, generally positionable between an occupant's legs and having a piece of webbing 202 and a buckle 204 at a distal end thereof (also shown in FIGS. 21A-21C). The harness 200 may additionally include a first strap 206 and a second strap 208, each having at least one piece of webbing and a latch 210 configured to selectively fasten to the buckle 204. The latches 210 can be releasably secured or fastened to the buckle 204 to secure a child in the child safety seat 24. Each of the first strap 206 and the second strap 208 may have a lap belt portion positionable over a lap of the child and a shoulder belt portion positionable over a shoulder of a child. In an embodiment, the lap belt portion, and the shoulder belt portion of each strap 206, 208 are separate pieces of webbing coupled to a latch 210. In another embodiment, the lap belt portion and the shoulder belt portion are integrally formed via a single piece of webbing. In such embodiments, the latch 210 is movable relative to the piece of webbing and the portion of the webbing arranged at a first side of the latch 210 forms the lap belt portion and the portion of the webbing at a second side of the latch 210 forms the shoulder belt portion.

In an embodiment, an end (not shown) of the webbing 202 of the crotch strap is attached to a portion of the support base 22, such as to the third base member 86 for example. Further, the webbing 202 may extend through at least one attachment member, such as first attachment member 120 for example. As shown, the first attachment member 120 may define a pocket 220 configured to receive and store the crotch strap when the harness 200 is not being used to restrain a child within the child safety seat 24. For example, the crotch strap can be stowed in the pocket 220 when the child safety seat 24 is used as a booster seat, without the harness 200.

An end of the lap belt portion and/or an end of the shoulder belt portion of each strap 206, 208 may be attached to a portion of the support base 22, such as to the third base member 86 for example. The ends of the lap belt portion and the shoulder belt portion may be coupled to the third base member 86 at a location disposed below the upper surface 110 thereof. In the illustrated, non-limiting embodiment, the ends of each lap belt portion extend through a corresponding attachment member, such as a respective second attachment member 122 for example.

The child safety seat 24 may have one or more openings formed therein to receive the straps of the harness 200 when the child safety seat 24 is mounted to the support base 22. For example, the shoulder belt portion of each strap 206, 208 may extend through a respective slit (not shown) formed in the upright support surface 30, or alternatively, in a portion of the headrest 46. In such embodiments, the slits may extend to an edge of the upright support surface 30, such as the top edge for example, or to an edge of the headrest to provide a path for installing the shoulder belt portions. In embodiments where the shoulder belt portions extend through slits formed in the headrest 46, the harness is operably coupled to the headrest 46.

In the illustrated non-limiting embodiment shown in FIGS. 6, 7 and 21A, the seat pan portion 28 of the child safety seat 24 has a first opening 230 formed in the seat positioning feature 130 configured to overlap with the first attachment member 120. The first opening 230 is sized to receive the buckle 204 of the crotch strap. Similarly, a slit 232 is associated with each respective seat positioning feature 130 configured to abut a second attachment member 122. As shown, the slits 232 form an opening at each seat positioning feature 130 and may extend beyond the seat positioning feature 130 in at least one direction to an edge, such as the back 54 for example, of the seat pan portion 28.

During installation of the seat pan portion 28 of the child safety seat 24 to the support base 22, the lap belt portion of each of the first and second straps 206, 208 is fed into the slits 232 and pulled into alignment with one of the seat positioning features 130. The buckle 204 of the crotch strap may similarly be passed through the corresponding opening 230 formed in a respective seat positioning feature 130. With each of the lap belt portions and the crotch strap accessible at the seat support surface 50 the seat pan portion 28, the seat pan portion 28 may then be lowered into position about the third base member 86 such that the seat positioning features 130 are aligned and engaged with the corresponding first and second attachment members 120, 122. Once in position, the seat pan portion 28 may be coupled to the third base member 86 and/or the seat back portion 26 as previously described. It should be appreciated that the harness 200 illustrated and described herein is intended as an example only and that a harness having any suitable configuration is contemplated herein.

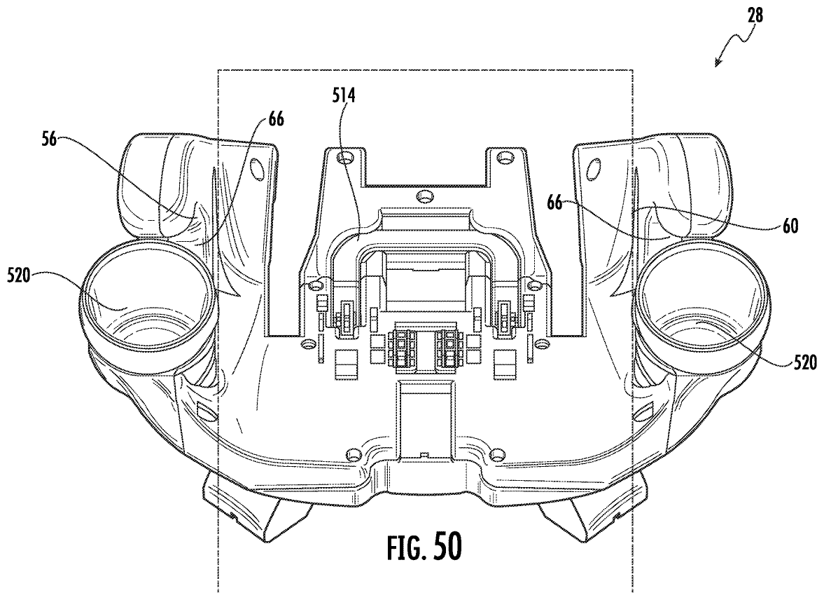

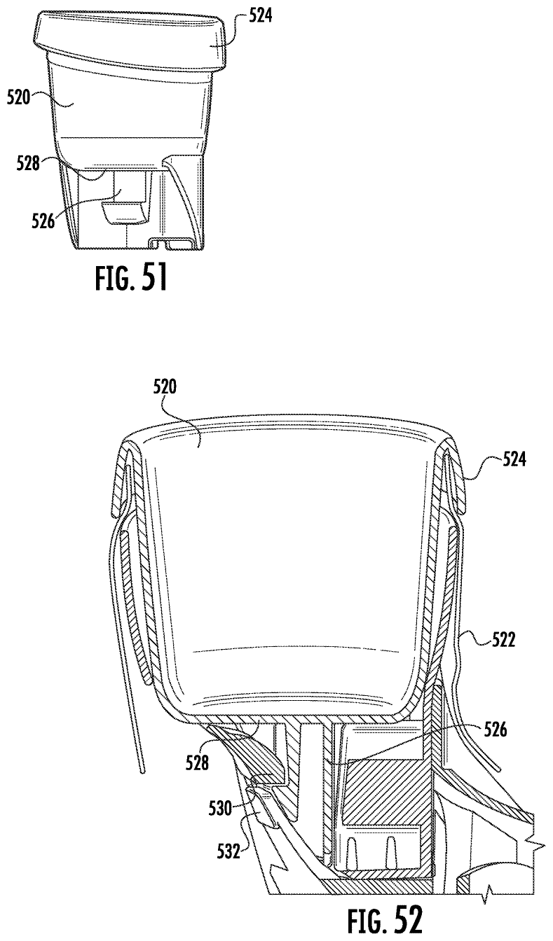

The seat pan portion 28 may include at least one cup holder 520. In the illustrated, non-limiting embodiment of FIGS. 50-52, the seat pan portion 28 includes a first cup holder 520 positioned at a first seat side member 56 and a second cupholder 520 positioned at a second seat side member 60. Although two cup holders 520 are illustrated, it should be understood that embodiments having only a single cup holder are also within the scope of the disclosure. The cup holders 520 may be arranged forward of the slots 66 formed in the seat side members 56, 60 configured to receive and position a lap belt portion of a vehicle belt. In an embodiment, the cup holders 520 are positioned to provide a seat occupant with adequate seating space while also providing sufficient clearance relative to the support base 22 of the child restraint system 20. As shown, the soft goods 522 may be configured to tuck into underneath a portion of the cup holder 520, such as a rim 524 of the cup holder 520 for example.

The cup holders 520 may be movable, and in some embodiments removable, relative to the seat pan portion 28. In an embodiment, the cup holder 520 includes a resilient or flexible snap finger 526 extending from a bottom 528 of the cup holder. The flexible snap finger 526 is configured to engage a protrusion 530 located at an interior of the seat pan portion 28 to restrict separation of the cup holder 520 from the seat pan portion 28. A flexible snap finger button 532 may be formed at an exterior surface of the seat pan portion 28 adjacent a portion of surface of the flexible snap finger 526. Application of a force to the flexible snap finger button 532 moves the flexible snap finger 526 out of engagement with the protrusion 530 to allow separation of the cup holder 520 from the seat pan portion 28. The removability of the cup holders 520 improves their while also providing a finished look with the adjacent soft goods 522.

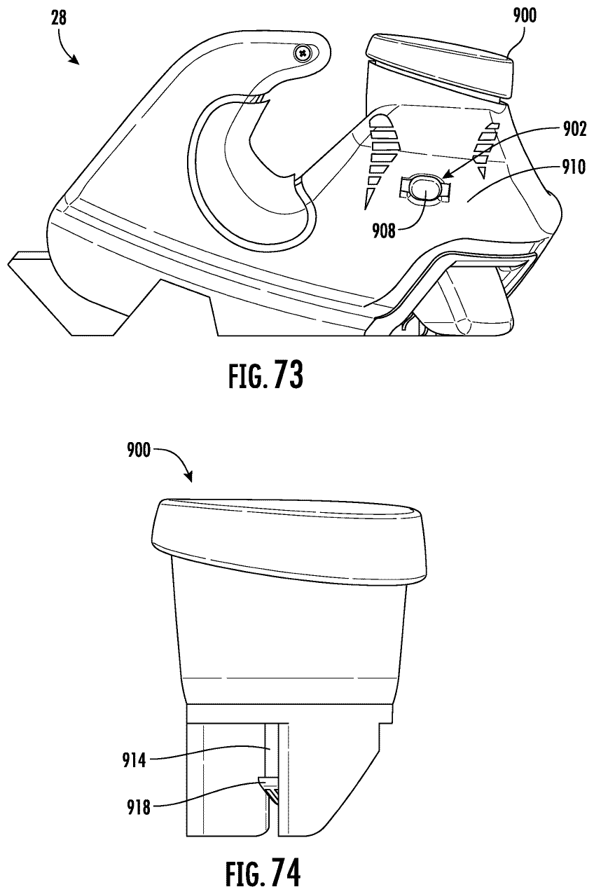

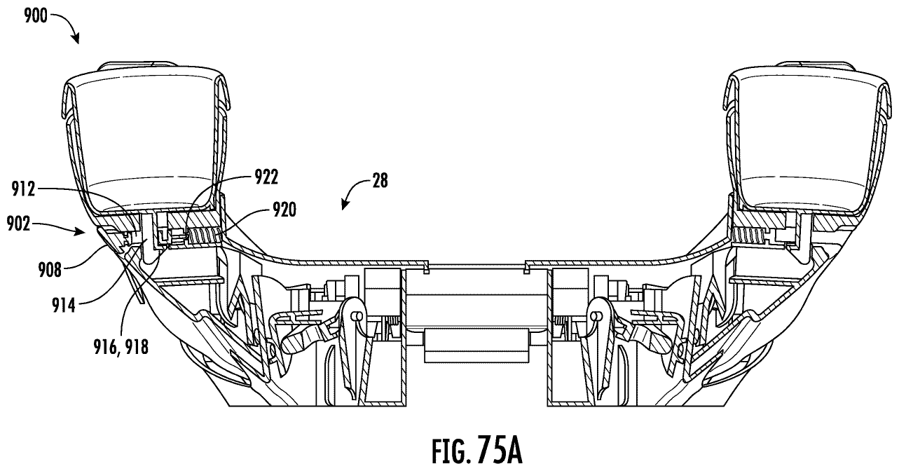

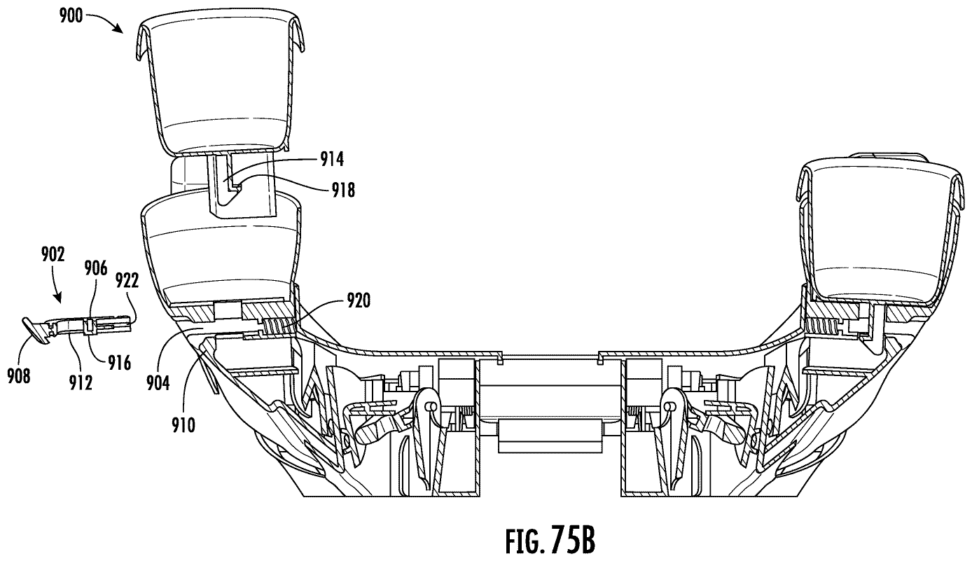

With reference to FIGS. 73-75B, an example of a seat pan portion 28 having a removable cup holder 900, similar to cupholder 520 is illustrated in more detail. As shown, an actuation mechanism 902 associated with the cup holder 900 is operable to selectively release the cupholder 900 from the seat pan portion 28. In the illustrated, non-limiting embodiment, the actuation mechanism 902 is removably couplable to the seat pan portion 28. As shown, the actuation mechanism 902 may be receivable within an opening 904 formed in a seat pan portion 28, such as directly underneath the cup holder 900. The actuation mechanism 902 may include a body 906 having a first end 908 positionable at an exterior 910 of the seat pan portion 28, such as a seat side member 56, 60 for example. The body 906 further includes a slot 912, and a flexible snap finger or other feature 914 extending the cup holder 900 is receivable within the slot 912. The body 906 may further define a surface 916 engageable by an end 918 of the feature 914 to restrict separation of the cup holder 900 from the seat pan portion 28. In an embodiment, a biasing mechanism 920 is mounted within an interior of the seat pan portion 28, adjacent to the opening 904 and is operably couplable to the actuation mechanism 902, such as to a second end 922 thereof for example. The biasing mechanism 920 is operable to bias the actuation mechanism 902 to an engaged position.

To decouple the cupholder 90 from the seat pan portion 28, a user applies a force to the first end 908 of the actuation mechanism 902. The force opposes the biasing force of the biasing mechanism 920, causing the body 906 to translate within the opening 904 formed in the seat pan portion 28. As a result of this translation, the surface 916 is moved out of engagement with the flexible snap finger 914, such that the flexible snap finger 914 is arranged within the slot 912 formed in the body 906. The cup holder 900 can be separated from or installed relative to the seat pan portion 28 when the actuation mechanism 902 is in this disengaged position. As shown, the actuation mechanism 902 may be removable from the seat pan portion 28 when the cup holder 900 is not installed about the seat pan portion 28.

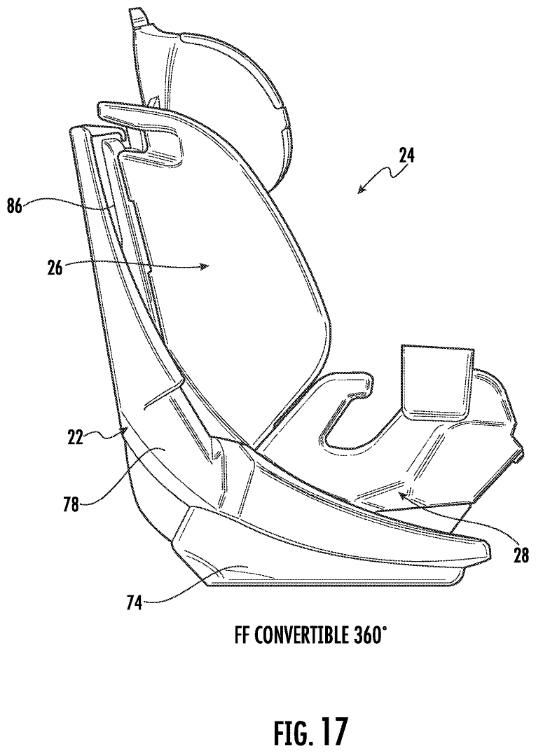

Referring now to FIGS. 16-19, various use configurations of the child safety seat system 20 are illustrated. FIG. 16 represents a use configuration of the child safety seat system 20 associated with an infant or a child up having a weight up to approximately 40 pounds. As shown, the child safety seat 24 is connected to the support base 22 and is rearward facing. In the infant configuration, a child is restrained within the child safety seat 24 using the harness 200 integral with the child safety seat system 20 and the support base 22 may be mounted to a vehicle seat 10 either using an integral LATCH system or using the vehicle belt. Another configuration of the child safety seat system 20 shown in FIG. 17 is associated with use by a toddler or a child older than two or weighing between approximately twenty-five and sixty-five pounds. In this toddler configuration, the child safety seat 24 is connected to the support base 22 and is forward-facing. Similar to the infant configuration, in the toddler configuration, a child is restrained within the child safety seat 24 using the harness 200 of the child safety seat system 20 and the support base 22 may be mounted to a vehicle seat 10 either using an integral LATCH system or using the vehicle belt.

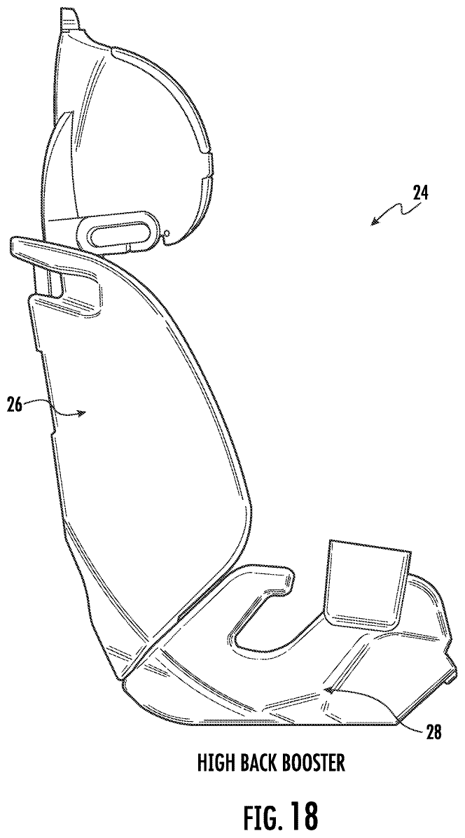

In other embodiments, the child safety seat 24 may be configured as a booster seat. For example, in embodiments where the both the seat pan portion 28 and the seat back portion 26 are separable from the support base 22, as shown in FIG. 18, the child safety seat 24 is forward-facing and may be arranged in direct contact with a vehicle seat 10. In this high back booster configuration, the child safety seat system 20 is intended for use by a child having a weight between about forty and about one hundred pounds. Further, a child is restrained within the child safety seat 24 using the vehicle belt. Although the child safety seat 24 is illustrated in a high-back booster configuration where the support base 22 is not present, it should be understood that the child safety seat 24 may also be used in a booster configuration while the child safety seat system 20 is attached to the support base 22. In such an embodiment, the child is restrained within the child safety seat 24 using the vehicle belt and not the harness 200.

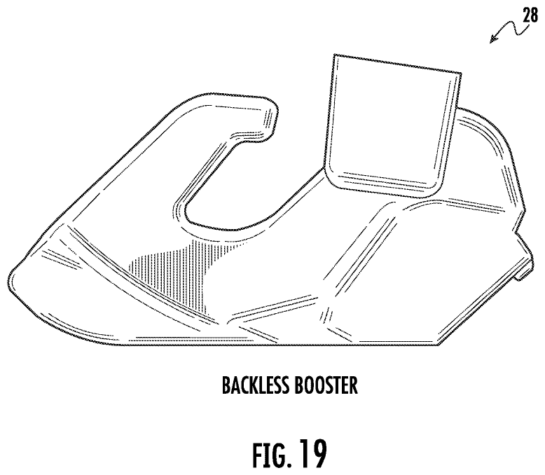

In a backless booster configuration (FIG. 19), only the seat pan portion 28 of the child safety seat 24 is forward-facing and in direct contact with a vehicle seat. The support base 22 and the seat back portion 26 of the child safety seat 24 are not present in the backless booster configuration. In such a configuration, the child safety seat 24 may be suitable for use by a child having a weight between about forty and about one hundred and twenty pounds and a child is restrained relative to the seat pan portion 28 by the vehicle belt.

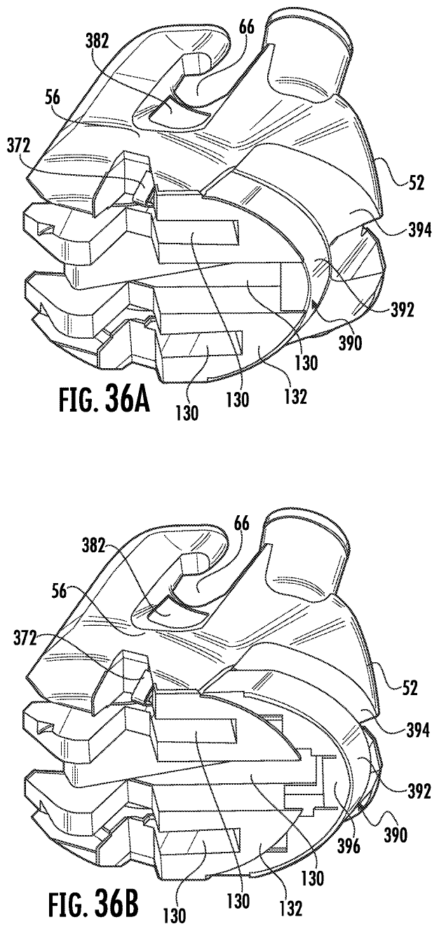

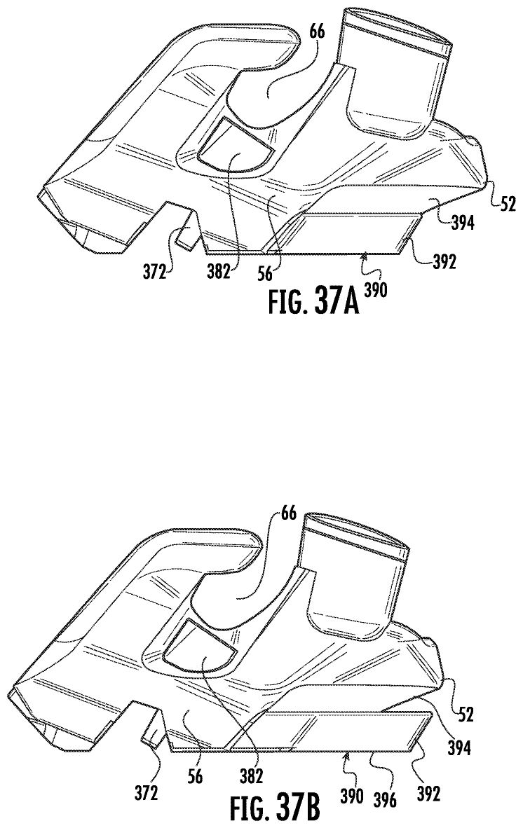

With reference to FIGS. 36A-37B, the seat pan portion 28 may include a stability foot 390. As shown, the stability foot 390 may be positioned at or adjacent to the bottom surface 132 of the seat pan portion 28. The stability foot 390 may be movable relative to the body of the seat pan portion 28. For example, the stowable stability foot 390 may be translatable between a first stowed configuration (FIGS. 36A, 37A) and a second, extended configuration (FIGS. 36B, 37B). In the first stowed configuration, a front surface 392 of the stability foot 390 is substantially aligned with the adjacent surface 394 of the body and in the second, extended configuration, the front surface 392 of the stability foot 390 is axially offset from the adjacent surface 394 of the body. In embodiments where the body slopes downwardly from the front edge 52 of the seat support surface 50 toward the rear of the seat pan portion 28, the front surface 392 of the stability foot 390 may be generally aligned with the front edge 52 when in the stowed configuration. In the extended configuration, the bottom surface 396 of the stability foot 390 (in addition to the bottom surface 132 of the seat pan portion 28) is positionable in contact with a support surface, such as a vehicle seat 10 for example. Accordingly, in the extended configuration, the footprint of the seat pan portion 28 is expanded, thereby increasing the stability of the seat pan portion 28.

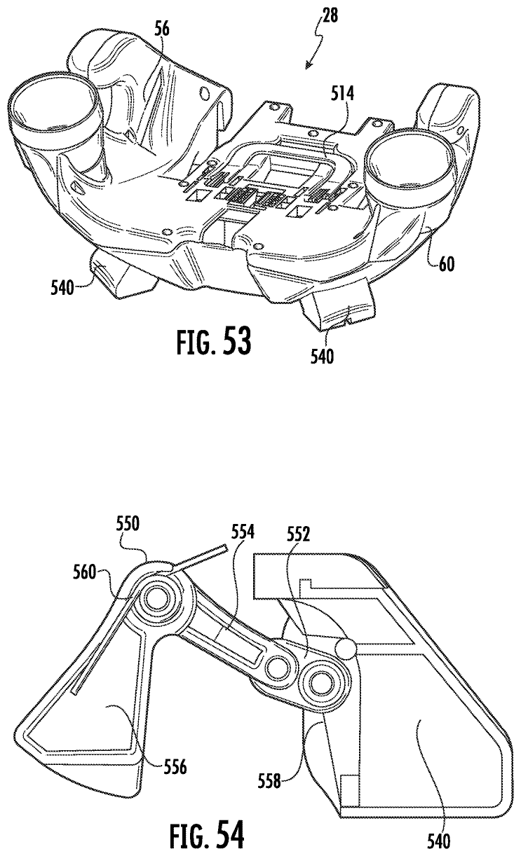

In other embodiments, illustrated in FIG. 53 the seat pan portion 28 may have a plurality of separate stability feet 540. For example, a first stability foot 540 may be arranged near a first seat side member 56 and a second stability foot 540 may be arranged near a second seat side member 60. In embodiments including a plurality of discrete stability feet, the stability feet 540 may but need not have identical configurations. Similar to the previous embodiment, the plurality of stability foot 540 may be movable relative to the seat pan portion 28 between a stowed configuration and an extended configuration. In embodiments including a plurality of stability feet 540, the stability feet 540 may be operated in unison, or alternatively, may be movable independently of one another.

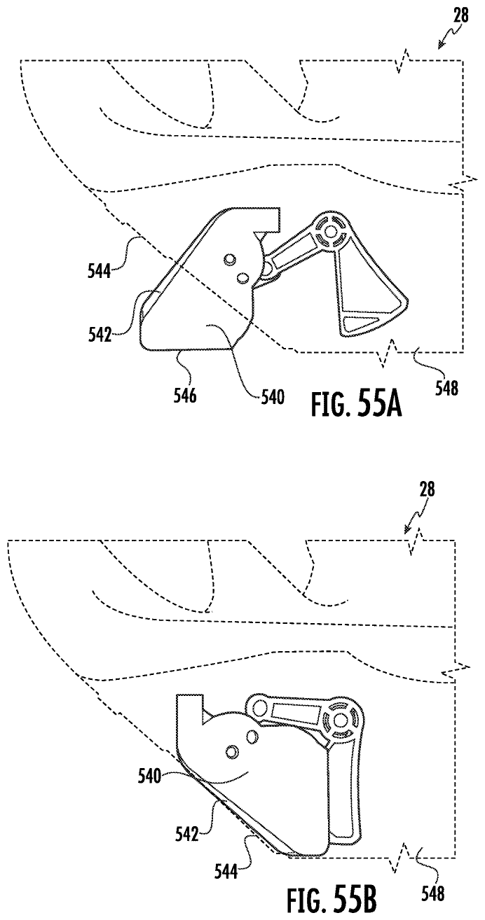

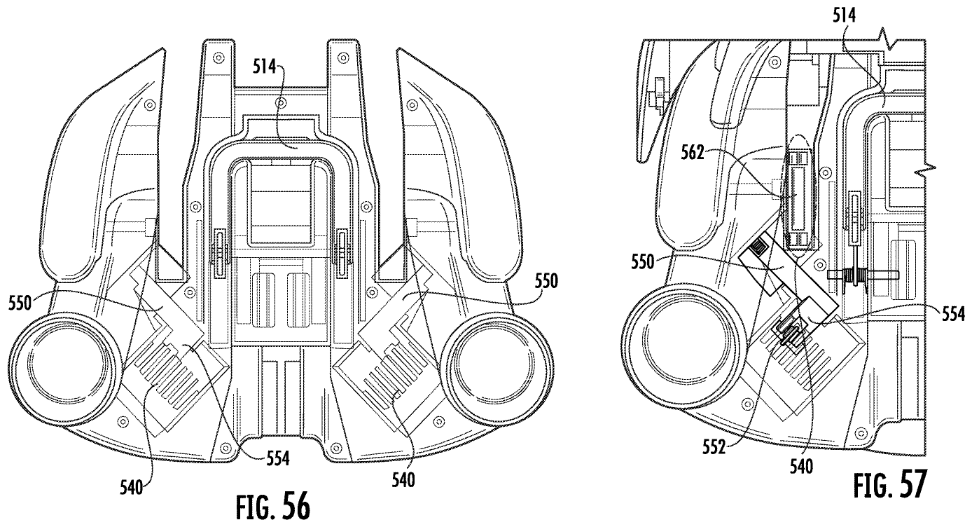

With reference to FIGS. 54-59, an example of a stability foot 540 is illustrated in more detail. In the stowed configuration, the at least one stability foot 540 may be at least partially, and in some embodiments wholly, arranged within an interior of the seat pan portion 28 (see FIG. 55B). In an embodiment, the at least one stability foot 540 has a sloped or angled front surface 542 and when the stability foot 540 is in the retracted configuration, the front surface 52 is parallel or substantially parallel with the angled front surface 544 of the seat pan portion 28. In the extended configuration, the one or more stability feet 540 protrude beyond a surface of the seat pan portion 28, such as the front surface 544 for example. In the illustrated, non-limiting embodiment, shown in FIG. 55A, a bottom 546 of the stability foot 540, when in the extended configuration, is spaced from and is substantially aligned with the bottom 548 of the seat pan portion 28. Accordingly, both the bottom 546 of the stability foot 540 and the bottom 548 of the seat pan portion 28 is positionable on a support surface, such as a vehicle seat 10 for example, when the seat pan portion 28 is used independently from the remainder of the child seat 24. In an embodiment, when the at least one stability foot 540 is in the extended configuration, the seat pan portion 28 has a different angle of incline relative to a vehicle seat than that of the seat pan portion 28 when the at least one stability foot is in a stowed configuration.

In an embodiment, the at least one stability foot 540 is rotatable between the stowed configuration and the extended configuration. However, embodiments where the at least one stability foot 540 is translatable or movable in another manner are also contemplated herein. In the illustrated, non-limiting embodiment, each stability foot 540 of the seat pan portion 28 is operably coupled to a respective retractor 550 by a linkage 552. As shown, the retractor 550 may include an engagement member 554 and a foot member 556 arranged at an angle relative to one another. Although the foot member 556 and engagement members 554 are illustrated as being generally perpendicular to one another, embodiments where the members 554, 556 are separated by another angle are also within the scope of the disclosure. The retractor 550 is rotatable relative to the seat pan portion 28 about an axis. The linkage 552 is pivotally coupled to an end of the foot member 554 and is pivotally coupled to a portion of the stability foot 540, such as a near a rear 558 of the stability foot 540 for example.

A biasing mechanism 560 is operably coupled to the stability foot 540 to bias the stability foot 540 to the extended configuration. In the illustrated, non-limiting embodiment, the biasing mechanism 560 is connected to the retractor 550; however, embodiments including a biasing mechanism 560 at another suitable location are also contemplated herein. Upon separation of the seat pan portion 28 from the third base member 86 of the child seat 24, the biasing force of the biasing mechanism 560 will cause a corresponding stability foot 540 to automatically transition from the retracted configuration to the extended configuration. Accordingly, if the seat pan portion 28 is not attached to a child seat 24, the stability foot 540 is extended to enhance the stability of the seat pan portion.

The stability feet 540 may be automatically retractable in response to connecting the seat pan portion 28 to the child seat 24, such as to the third base member 86. In an embodiment, the third base member 86 includes a booster receiver 562 (FIG. 57) arranged in alignment with a corresponding retractor 550. When the seat pan portion 28 is attached to the third base member 86, the booster receiver 562 engages a corresponding retractor 550. This engagement applies a force to the retractor 550 causing the retractor 550 to rotate about its axis, such as toward the front of the seat pan portion 28. This rotation of the retractor 550 drives a corresponding rotation of the stability foot 540 in an opposite direction. Accordingly, as the retractor 550 is rotated by the booster receiver 562, the stability foot 540 rotates in an opposite direction, such as toward the interior of the seat pan portion 28 and the retractor 550, via the linkage 552. The retractor 550 is retained in this rotated position while the seat pan portion 28 remains coupled to the third base member 86. Upon separation of the seat pan portion 28 from the third base member 86, the biasing force acting on the retractor 550 will cause the retractor 550 to rotate to drive the corresponding stability foot 540 forward to the extended configuration.

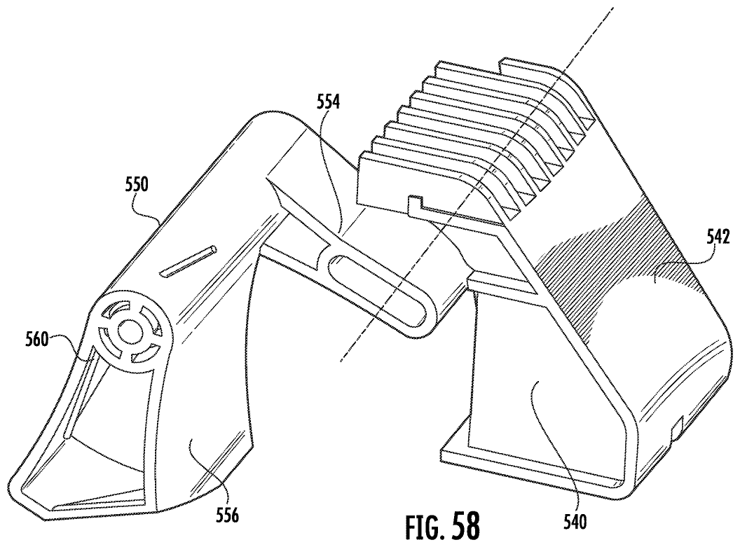

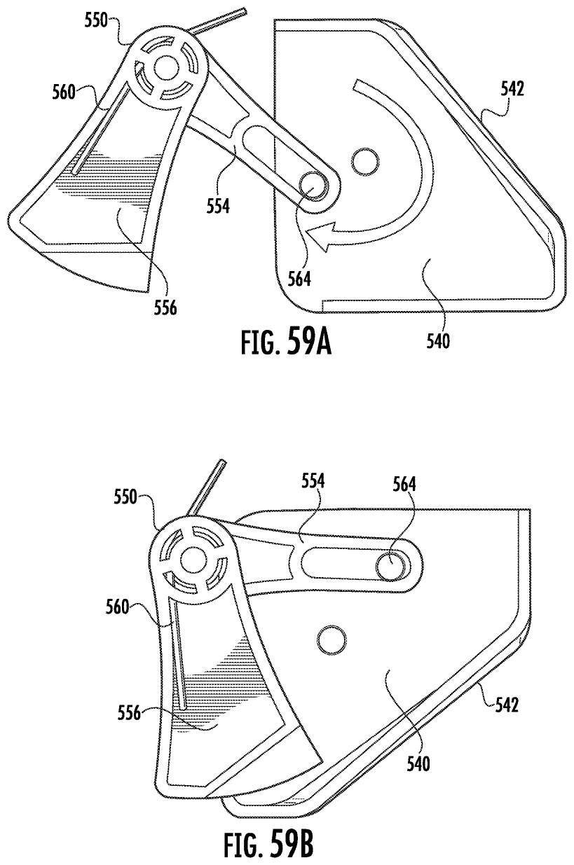

With reference to FIGS. 58-59B, in another embodiment, instead of being operably coupled by a linkage, the foot member 554 of the retractor 550 may be pinned (via pin 564) directly to the stability foot 540. Operation of a such a configuration is substantially identical to that of the embodiment of FIGS. 54-57. As previously noted, engagement with booster receiver 562 drives the retractor 550, and therefore the stability foot 540 coupled to the retractor 550, to the retracted configuration. Once the seat pan portion 28 is separated from the third base member 86, the biasing force of the biasing mechanism 560 acting on the retractor 550 will automatically rotate the retractor 550, thereby driving the stability foot 540 forward to the extended configuration.

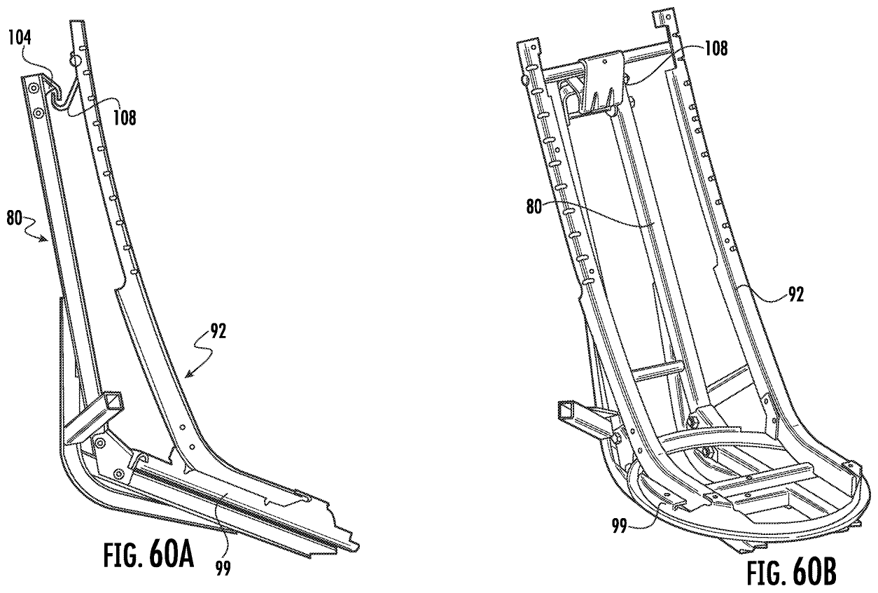

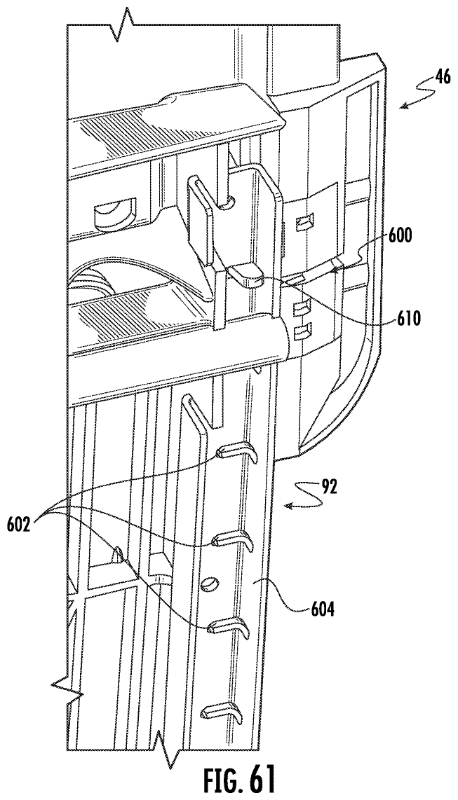

With reference now to FIGS. 60A-60B, in an embodiment, at least a portion of the metal structural frame of the support base 22 is formed from aluminum. For example, at least one of the rigid frame 80 of the second base member 78 and the spin carriage 92 of the third base member 86 may be formed from aluminum. However, it should be understood that while part of the structural frame of the support base 22 may be formed from aluminum, another part of the structural frame may be formed from a different material, such as steel for example. In the non-limiting embodiment illustrated in FIGS., both the rigid frame 80 and the spin carriage 92 are formed from a first material, such as aluminum. In such embodiments, one or more components arranged at an interface between the rigid frame 80 and the spin carriage 92 are formed from a second material, such as steel for example. As shown, the bottom spin cover 99 disposed between the rigid frame 80 and the spin carriage 92 is formed from steel material. Similarly, the base anchor member 104 arranged near an end of the rigid frame 80 and the seat anchor member 108 arranged at a corresponding location of the spin carriage 92 may be formed from a steel material. Use of this combination of materials may require additional bolt connections. However, it should be understood that embodiments where the structural frame of the support base 22 is formed from another material or another combination of materials including metal alloys that has sufficient strength for the application are also within the scope of the disclosure.

The headrest 46 of a child seat 24 as described herein may be movable relative to the upright support surface 30 of the child seat 24 between a retracted position and an extended position, allowing for adjustment based on the size of the child positioned within the child seat 24. A locking mechanism 600 operable to selectively lock a headrest 46 in a position relative to the child seat 24 typically includes a component associated with the headrest 46 and receivable within one of a plurality of openings of slots 602 formed in a channel 604 at or adjacent to the upright support surface 30. In an embodiment, a portion of the spin carriage 92 forms the channel 604 including a plurality of slots 602 that define the respective positions of the headrest 46.

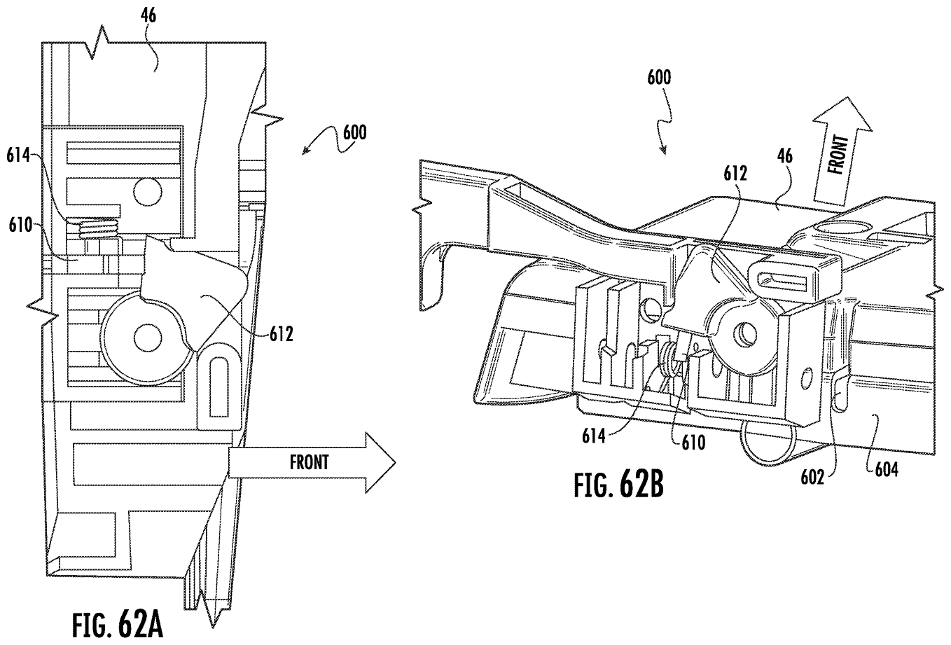

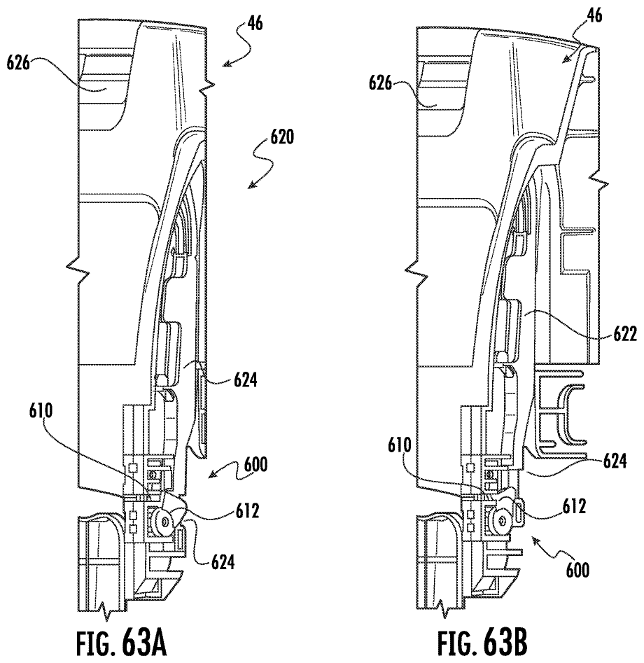

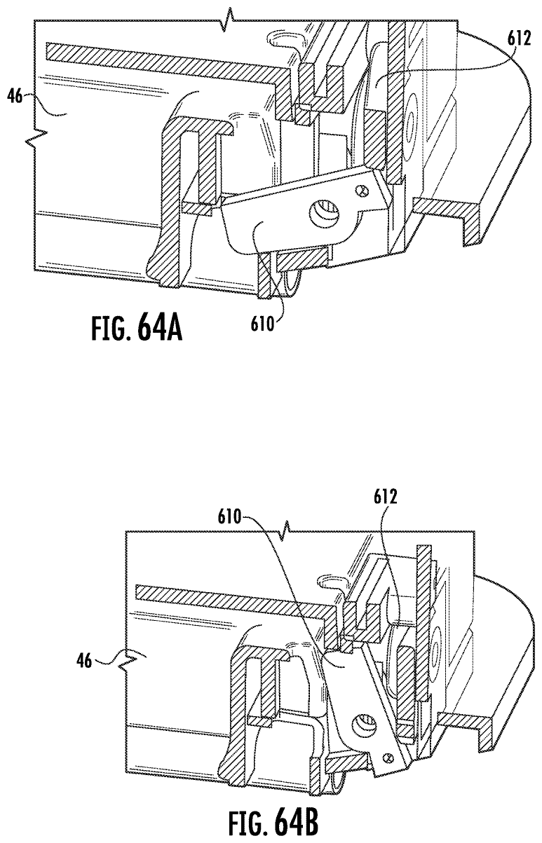

In embodiments where the spin carriage 92 is formed from an aluminum material, existing locking mechanisms may not be suitable to interact with an aluminum component. In the illustrated, non-limiting embodiment, the locking mechanism 600 includes a first lock member 610 operably coupled to a second lock member 612. The first lock member 610 may be movable, for example rotatable about an axis, relative to the headrest 46 between a locked position (FIGS. 62A, 62B, 63A, 64A) in which the first lock member 610 is engaged with a slot 602 and an unlocked position (FIGS. 63B and 64B) in which the first lock member 610 is separated or disengaged from the plurality of slots 602. The second lock member 612 is also movable relative to the headrest 46. For example, the second lock member 612 may be rotatable about an axis between a disengaged position and an engaged position. In the illustrated, non-limiting embodiment, the type and/or direction of movement of the second lock member 612 is different than that of the first lock member 610. As shown, an axis of rotation of the second lock member 612 is arranged at a non-parallel angle to the axis of rotation of the first lock member 610. For example, the axes may be perpendicular to one another. However, any suitable configuration of the first and second lock members 610, 612 is within the scope of the disclosure. A biasing mechanism 614, such as a torsion or spring for example, may be operably coupled to the first lock member 610 and may bias the first lock member 610 into engagement with an adjacent slot 602.

The locking mechanism 600 may be part of an actuation mechanism 620 associated with movement of the headrest 46. In an embodiment, the actuation mechanism 620 includes at least one linking member 622. Although only a single linking member 622 is illustrated in the FIGS., it should be understood that in some embodiments, the actuation mechanism 620 may include a plurality of linking members 622, such as a linking member associated with each channel 604 of slots 602 and a corresponding locking mechanism 600. In the illustrated, non-limiting embodiment, a portion of the second lock member 612 is receivable within an opening 624 formed in the linking member 622 when the actuation mechanism 620 is unactuated.

The actuation mechanism 620 additionally includes an actuator 626, such as a handle for example, arranged at an exterior of the headrest 46 for access by a user. In the illustrated, non-limiting embodiment, the actuator 626 is disposed at or proximate a top of the headrest 46. The at least one linking member 622 is operably coupled to the actuator 626. For example, a first end (not shown) of each linking member 622 may be connected to, or in some embodiments integrally formed with, the actuator 626.

The first lock member 610 is disengageable from a respective slot 602 in response to operation of the actuator 626, such as via application of a force to the actuator 626. Once disengaged, the headrest 46 is movable relative to the child seat 24. When the user applies a force to the actuator 626, the force is transmitted to the at least one linking member 622 causing the at least one linking member 622 to translate relative to the headrest 46. As the linking member 622 translates, a surface of the linking member 622 engages and applies a force to the second lock member 612 causing the second lock member 612 to rotate about its axis toward the first lock member 610. As it rotates, the second lock member 612 engages a portion of the first lock member 610. The force transmitted to the first lock member 610 by the second lock member 612 opposes the biasing force of the biasing mechanism 614, thereby causing the first lock member 610 to rotate out of engagement with a slot 602.

When the actuator 626 is released, the biasing force of the biasing mechanism 614 will rotate the first lock member 610 into engagement with a corresponding slot 602. The rotation of the first lock member 610 will drive a similar rotation of the second lock member 612. As the second lock member 612 rotates about its axis, it will apply a force to a corresponding portion of the linking member 622, causing the linking member 622 to translate downwardly so that the second lock member 612 is received within the opening 624 of the linking member 622.

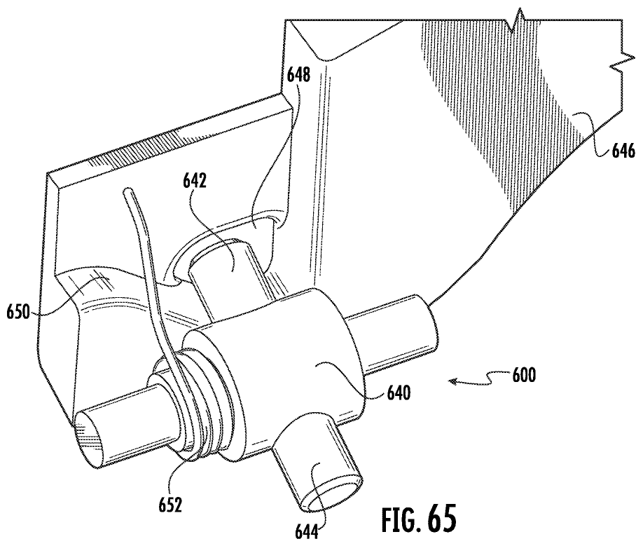

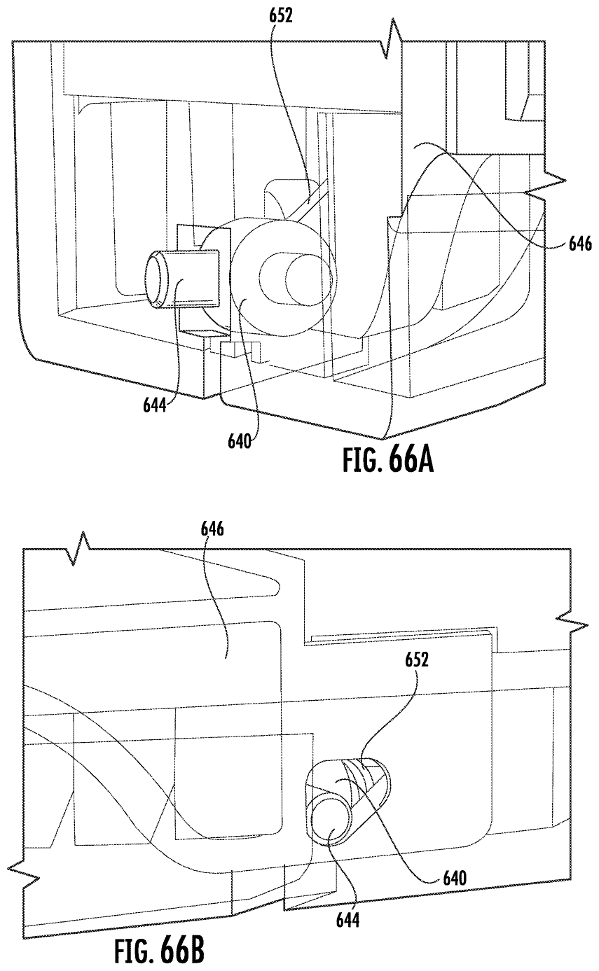

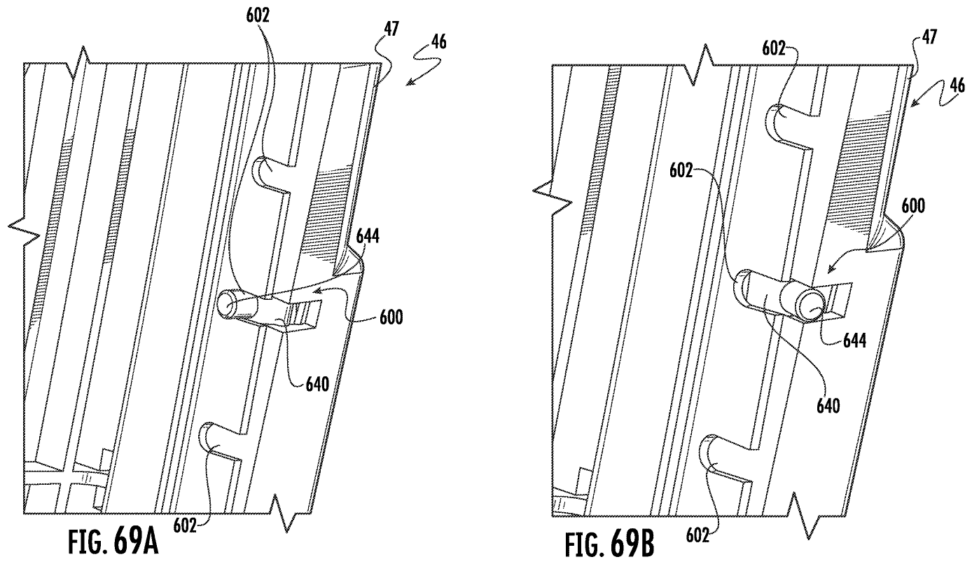

Yet another embodiment of a headrest locking mechanism 600 associated with a headrest 46 is illustrated in FIGS. 65-69B. As shown, the locking mechanism 600 includes a single lock member 640 having a first or ramp engagement member 642 and a second or slot engagement member 644. The lock member 640 may be arranged in direct contact with a portion of a linking member 646. In the illustrated, non-limiting embodiment, the linking member 646 includes an opening 648 and a ramped surface 650 extending from the opening 648. However, it should be appreciated that embodiments where the linking member 646 does not include an opening 648 are also within the scope of the disclosure. A biasing mechanism 652 is operably coupled to the lock member 640 to bias the slot engagement member 644 into engagement with a slot associated with a position of the headrest 46, such as slot 602 (see FIGS. 69A-69B).

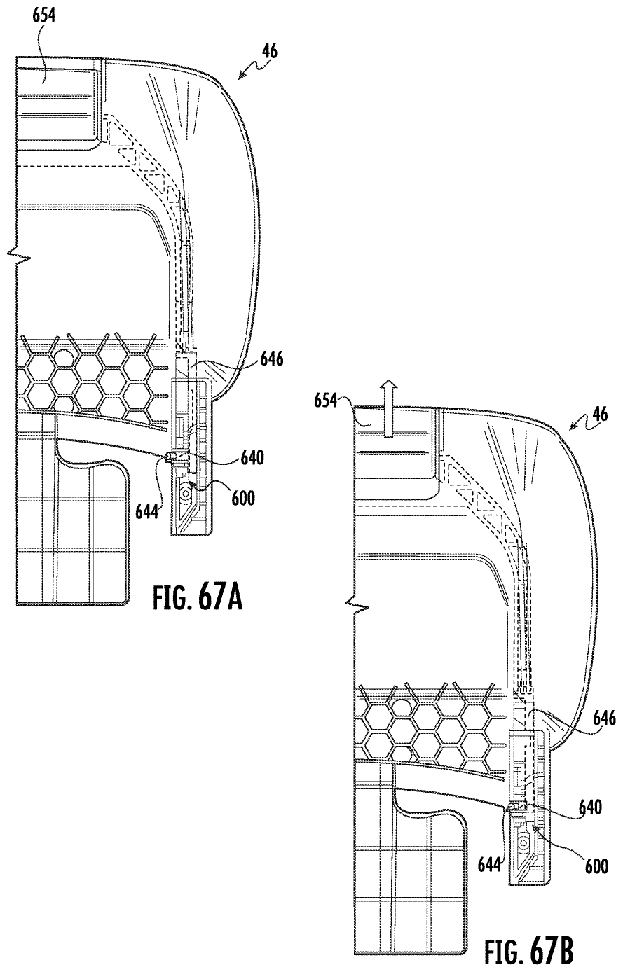

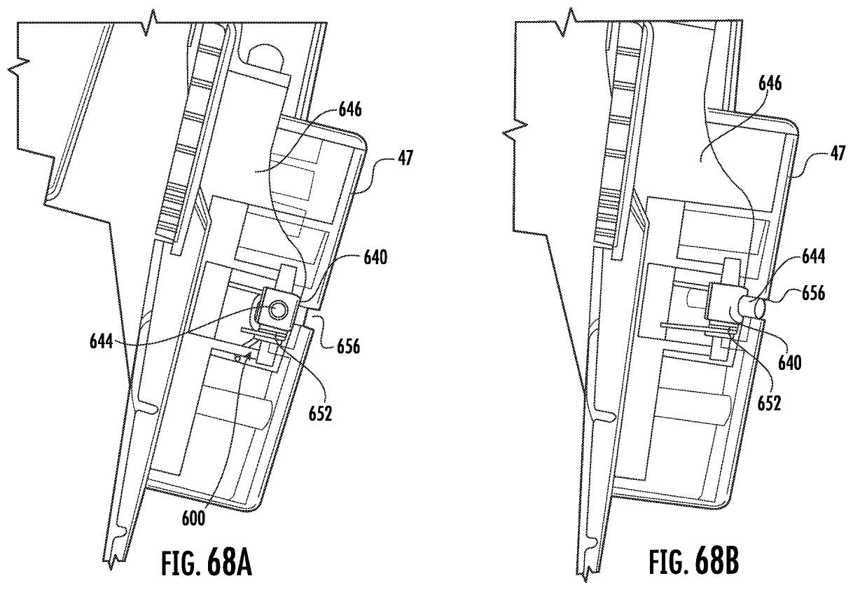

As previously described, the linking member 646 may be operably coupled to, and in some embodiments integrally formed with, an actuator 654 accessible by a user. In response to application of a force to the actuator 654, the linking member 646 translates relative to the headrest 46. As the linking member 646 translates, the ramp engagement member 642 slides along the ramped surface 650. As the slope of the ramped surface 650 increases, this engagement causes the lock member 640 to pivot about its longitudinal axis. This rotation of the lock member 640 opposes the biasing force of the biasing mechanism 652 and moves the slot engagement member 644 out of a corresponding slot 602 (FIGS. 67B, 68B, 69B). As shown in FIGS. 68A-69B, a disengagement slot 656 may be formed in a portion of the headrest 46, such as the headrest shell 47 for example, aligned with the slot engagement member. Accordingly, as the slot engagement member 644 rotates out of engagement with the slot 602 associated with the child seat, the slot engagement member 644 is received within the disengagement slot 656 of the headrest 46. When the actuator 654 is released, gravity may cause the linking member 646 to move downwardly relative to the headrest 46 such that the ramped surface 650 disengages from the ramp engagement surface. Further, the biasing force of the biasing mechanism 652 will rotate the lock member 640 back into engagement with a corresponding slot 602 to lock the headrest in a position to the slot. However, it should be understood that in some embodiments, the biasing force of the biasing mechanism 652 may be sufficient to both move the ramped surface 650 away from the ramp engagement member 642 and rotate the lock member 640 about its axis.

The child safety seat system 20 as described herein allows the rotational configuration and the incline of a child safety seat 24 to be adjusted relative to the support base 22 and a vehicle seat 10.

The term “about” is intended to include the degree of error associated with measurement of the particular quantity based upon the equipment available at the time of filing the application. As used herein, the term “substantially” and derivatives thereof, and words of similar import, when used to describe a size, shape, orientation, distance, spatial relationship, or other parameter includes the stated size, shape, orientation, distance, spatial relationship, or other parameter, and can also include a range up to 10% more and up to 10% less than the stated parameter, including 5% more and 5% less, including 3% more and 3% less, including 1% more and 1% less.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A child safety seat system positionable on a vehicle seat, the child safety seat system comprising:
a support base; and
a child safety seat rotatably positionable on the support base;
wherein the child safety seat includes a first booster portion and a second booster portion, the first booster portion being separable from the second booster portion.

2. The child safety seat system of claim 1, wherein at least one of the first booster portion and the second booster portion is removably couplable to the support base.

3. The child safety seat system of claim 1, wherein at least one of the first booster portion and the second booster portion is loosely positionable about the support base.

4. The child safety seat system of claim 1, wherein at least one of the first booster portion and the second booster portion is couplable to the support base via a booster locking mechanism.

5. The child safety seat system of claim 4, wherein the booster locking mechanism further comprises:
at least one locking member movably mounted to the at least one of the first booster portion and the second booster portion; and
an actuator operably coupled to the at least one locking member, the actuator being operable to transform the at least one locking member from a locked position to an unlocked position.

6. The child safety seat system of claim 1, wherein both the first booster portion and the second booster portion are removably couplable from the support base, the first booster portion being separable from the support base independently from the second booster portion.

7. The child safety seat system of claim 1, wherein the first booster portion is a seat back portion of the child safety seat and the second booster portion is a seat pan portion of the child safety seat.

8. The child safety seat system of claim 1, wherein the support base further comprises:
a first base member;
a second base member movably mounted to the first base member; and
a third base member movably mounted to the second base member.

9. The child safety seat system of claim 8, wherein the child safety seat is connectable directly to the third base member.

10. The child safety seat system of claim 8, wherein the third base member further comprises at least one attachment member and the second booster portion further comprises at least one positioning feature, the at least one attachment member being engageable with the at least one positioning feature to position the second booster portion about the support base.

11. The child safety seat system of claim 8, wherein the third base member further comprises at least one base interlock feature and the first booster portion further comprises at least one seat interlock feature, the at least one base interlock feature being engageable with the at least one seat interlock feature to couple the second booster portion to the support base.

12. The child safety seat system of claim 11, wherein the second booster portion further comprises an engagement feature movable relative to the second booster portion to selectively engage the at least one base interlock feature.

13. The child safety seat system of claim 12, wherein the engagement feature is a pin lock, the pin lock being translatable into an opening formed in the at least one base interlock feature.

14. The child safety seat system of claim 8, wherein the child safety seat further comprises at least one seat interlock feature and the third base member further comprises at least one base interlock feature, the at least one base interlock feature being engageable with the at least one seat interlock feature to couple the third base member to the child safety seat.

15. The child safety seat system of claim 8, wherein the third base member is rotatable with the child safety seat relative to the second base member.

16. The child safety seat system of claim 15, wherein the second base member further comprises a hook and the third base member further comprises a lip, the hook being engaged with the lip to define a path of rotation of the child safety seat.

17. The child safety seat system of claim 8, wherein the child safety seat is rotatable relative to the support base between a rearward-facing configuration and a forward-facing configuration, the second base member further comprises a base anchor member and the third base member further comprises a seat anchor member, wherein the base anchor member is connectable to the seat anchor member when the child safety seat is in the forward-facing configuration.

18. The child safety seat system of claim 8, wherein the child safety seat is movable along an incline path relative to the support base.

19. The child safety seat system of claim 18, wherein the child safety seat is movable with the second base member and the third base member relative to the first base member along the incline path to adjust an incline of the child safety seat.

20. The child safety seat system of claim 18, further comprising:
a recline lock mechanism for selectively locking the child safety seat at a one of a plurality of positions along the incline path; and
an actuator operably coupled to the recline lock mechanism, wherein the actuator is operable to transform the recline lock mechanism between a locked position and an unlocked position.

21. The child safety seat system of claim 1, further comprising:
a spin lock for selectively locking rotation of the child safety seat relative to the support base; and
at least one actuator operably coupled to the spin lock, wherein the at least one actuator is operable to transform the spin lock between a locked position and an unlocked position.

22. The child safety seat system of claim 21, wherein the spin lock further comprises a plurality of lock pins and the support base further comprises a plurality of lock sections, the plurality of lock pins being engaged with the plurality of lock sections when the spin lock is in the locked position and the plurality of lock pins being disengaged from the plurality of lock sections when the spin lock is in the unlocked position.

23. The child safety seat system of claim 22, wherein the plurality of lock pins are operably coupled to one another by a connecting link.

24. The child safety seat system of claim 22, wherein the at least one actuator further comprises a handle and a tension member operably coupling the handle to one of the plurality of lock pins.

25. The child safety seat system of claim 1, wherein the support base further comprises a harness, the harness being receivable within at least one opening formed in the child safety seat when the child safety seat is connected to the support base.

26. The child safety seat system of claim 1, wherein the first booster portion includes at least one impact pod.

27. The child safety seat system of claim 26, wherein the first booster portion is a seat back portion, the at least one impact pod being arranged at a rear of the seat back portion.

28. The child safety seat system of claim 27, wherein the at least one impact pod substantially encircles the rear of the seat back portion.

29. The child safety seat system of claim 26, wherein when the child safety seat is in a forward-facing configuration, the at least one impact pod is vertically offset from the support base.

30. The child safety seat system of claim 1, wherein the second booster portion further comprises a stability foot movable between a retracted position and an extended position.

31. The child safety seat system of claim 30, wherein a bottom of the stability foot is positionable in contact with the vehicle seat in the extended position.

32. The child safety seat system of claim 1, further comprising a belt tensioner mounted to the support base, the belt tensioner being movable between an open position and a closed position to apply a tension to a vehicle belt associated with the vehicle seat.

33. The child safety seat system of claim 1, wherein the first booster portion includes a cup holder, the cup holder being separable from the first booster portion.

34. The child safety seat system of claim 33, wherein the cup holder includes a flexible snap finger engageable with a protrusion extending from the first booster portion.

35.-112. (canceled)
